(19) United States
(12) Patent Application Publication
(10) Pub. No.: US 2016/0093009 A1
(43) Pub. Date: Mar. 31, 2016

(54) TECHNIQUES FOR FACILITATING A NEGOTIATION

(71) Applicant: 1stdibs.com, Inc., New York, NY (US)

(72) Inventors: Jay Goldklang, New York, NY (US); Xiaodi Zhang, New York, NY (US); Ross Paul, Brooklyn, NY (US); Matthew Mason, Brooklyn, NY (US); Vadim Leyzerovich, Springfield, NJ (US)

(21) Appl. No.: 14/497,552

(22) Filed: Sep. 26, 2014

(51) Int. Cl. G06Q 50/18; G06Q 20/40

(52) U.S. Cl. CPC G06Q 50/188; G06Q 20/40

(57) ABSTRACT

In some embodiments, a presentation offering one or more items is provided on a computing device and an offer for purchase of an item of the one or more items is received. In some instances, the offer for purchase identifies an offer amount. Payment method information related to a payment method is received and a request to authorize the payment method in a reserve amount can be transmitted. A confirmation that the payment method is authorized in the reserve amount can be received and a notification identifying the item and the first offer can be generated. The notification can include an option to respond to the first offer, in some instances, the option to respond can include an option to accept the first offer and an option to provide a counteroffer.

### FIELD OF INVENTION

Generally, systems and methods herein relate to automated facilitation of a multi-party, iterative negotiation.

### BACKGROUND

Conventionally, negotiating the purchase of an item can be frustrating to a seller due to the time required to come to an agreement on price, followed by the need to collect payment from the buyer once a price is agreed upon. A seller can spend large quantities of time negotiating the sale of an item only to have the buyer later fail to pay the agreed upon price, or only make the payment after the seller has spent time and effort repeatedly requesting payment from the buyer. In some instances, a seller can spend large quantities of time responding to multiple initial offers to purchase an item only to have the various buyers fail to respond to the seller's communications regarding the initial offers, including in some instances the seller's acceptance of a buyer's offer of purchase. In each instance the seller spends time negotiating the sale of an item only to have a sale fail to be completed or only get completed after a great deal of time and effort to collect payment from the buyer.

### SUMMARY

In some embodiments, a presentation offering one or more items for sale is provided on a computing device. An offer for purchase of an item of the one or more items can be received. The offer for purchase can include an offer amount which can be the same or different from an asking price of the item. Payment method information corresponding to a payment method can be received and a request to authorize the payment method in a reserve amount can be transmitted. A confirmation that the payment method is authorized in the reserve amount can be received. A notification identifying the item and the first offer can be generated. The notification can include an option to respond to the first offer. In some instances the option to respond can include an option to accept the first offer and an option to provide a counteroffer.

Where a response to the first offer corresponding to an acceptance of the first offer is received, in some instances, a request for an additional fee can also be received. A notification that identifies the acceptance of the first offer and the request for the additional fee can be generated. The notification can include an option to accept the request for the additional fee. In some instances the notification can include an option to provide a counteroffer to the additional fee. Where a response is received that identifies an acceptance of the additional fee; a request to approve a charge of the payment method in the additional fee amount can be generated. An approval to charge the payment method in the additional fee amount can be received and a request to charge the payment method in the additional fee amount is also transmitted. A request to settle the authorization of the payment method in the reserve amount can also be transmitted.

In some embodiments, a presentation offering an item for sale by a seller is provided on a computing device. An offer for purchase of the item including an offer amount and a buyer shipping address can be received. A notification identifying the item and the offer can be generated. The notification can include an option to respond to the offer with a request for an additional fee. An option to request a quote for the additional fee can be presented and a selection of the option to request a quote for the additional fee can be detected. A quote for the additional fee can be generated. A quote notification that includes the quote for the additional fee can be generated. The quote notification can include a first option to select the quote for the additional fee and a second option to provide a user quote for the additional fee.

In some embodiments, the quote for the additional fee can be generated based at least in part on information related to a prior transaction of the seller. The quote for the additional fee can be generated based at least in part on item information corresponding to a prior purchase of a substantially similar item. The item information can be, for example but not limited to, an item purchase price, or an item size. A quote for a shipping fee can be generated based at least in part on a previous shipping fee associated with a prior transaction of the seller. The quote for the shipping fee can be generated based in part on item information associated with the item and a previous shipping fee associated with a prior transaction for purchase of a substantially similar item. For example, the item information can include an item type, an item purchase price, and an item size. A selection corresponding to a time period for handling the shipment of the item can be detected. A selection corresponding to a level of shipping service can also be detected. The shipping quote can be generated based in part on the time period for handling the shipment of the item and the level of shipping service. The additional fee can be, for example, but not limited to, a shipping fee or an insurance fee.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of a negotiation purchasing system;

FIG. 2A depicts a block diagram of an embodiment of a negotiation management system;

FIG. 2B depicts a block diagram of an embodiment of a price negotiation engine shown in FIG. 2A.

FIG. 3 illustrates a flowchart of an embodiment of a process for negotiating a purchase and collecting payment;

FIG. 4 illustrates a flowchart of an embodiment of a process for negotiating a purchase of an item and updating a status of the negotiation of the item's purchase;

FIG. 5 illustrates a flowchart of an embodiment of a process for engaging in an iterative offer and counteroffer negotiation, including collecting payment;

FIG. 6 illustrates a flowchart of an embodiment of a process for collecting a balance due payment;

FIG. 7 illustrates a flowchart of an embodiment of a process for negotiating and processing an additional fee;

FIG. 8 depicts a block diagram of an embodiment of a computer system;

FIG. 9 depicts a block diagram of an embodiment of a special-purpose computer system;

FIG. 10 depicts an exemplary screen shot of a series of item records rendered and displayed on a user device;

FIG. 11 depicts an exemplary screen shot of a detailed item record rendered and displayed on a user device;

FIG. 12 depicts an exemplary screen shot of an interface presented in response to the detection of input corresponding to a request for purchase of an item, rendered and displayed on a user device;

FIG. 13 depicts an exemplary screen shot of a notification identifying a first offer, rendered and displayed on a user device;

FIG. 14 depicts an exemplary screen shot of an interface presenting various options for responding to a first offer, rendered and displayed on a user device;

FIG. 15 depicts an exemplary screen shot of an interface presenting various data fields for receiving a counteroffer and request for an additional fee, rendered and displayed on a user device;

FIG. 16 depicts an exemplary screen shot of an interface that prompts the seller to request a shipping quote or provide a shipping quote; and

FIG. 17 depicts an exemplary screen shot of an interface that prompts the seller to select the use of the system quote or to provide a different shipping quote.

In the appended figures, similar components and/or features may have the same reference label.

### DETAILED DESCRIPTION

The ensuing description provides exemplary embodiment(s) only, and is not intended to limit the scope, applicability, or configuration of the disclosure. Rather, the ensuing description of the exemplary embodiments will provide those skilled in the art with an enabling description for implementing an exemplary embodiment(s). It should be understood that various changes may be made in the function and arrangement of elements without departing from the spirit and scope of the invention as set forth in the appended claims.

In the following description, for the purposes of explanation, specific details are given to provide a thorough understanding of the embodiments. However, it will be understood by one of ordinary skill in the art that the embodiments may be practiced without these specific details. The figures and description are not intended to be restrictive. For example, circuits, systems, networks, processes, and other components may be shown as components in block diagram form in order not to obscure the embodiments in unnecessary detail. In some instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to, portable or non-portable storage devices, optical storage devices, wireless channels, and various other mediums capable of storing, containing or carrying instruction(s) and/or data. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein, the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure. Systems depicted in some of the figures may be provided in various configurations. In some embodiments, the systems may be configured as a distributed system where one or more components of the system are distributed across one or more networks in a cloud computing system.

A negotiation management system can be made available to one or more users such as a buyer or a seller via an app (that can be downloaded to and executed on a portable electronic device) or a website. A system can present via a buyer interface various items offered for sale by one or more sellers or dealers. An item can be a tangible good (e.g. a table), an intangible good (e.g. software), or a service (e.g. home cleaning) The system can present information related to the items offered for sale by a seller corresponding to input detected by a seller interface (e.g. item description, asking price (or purchase price), etc.).

The buyer interface may detect input corresponding to a first offer to purchase an item at a lower price than the asking price. The first offer can include input corresponding to a first offer amount, shipping details (e.g. buyer will pick up or shipping is required), and payment method (e.g. credit card, debit card, online payment account, ACH transfer from bank account, etc.), payment information (e.g. card number, expiration date, CVC/CVV code, billing address), and/or information sufficient to process a payment in the first offer amount or a different amount (e.g. the first offer amount plus sales tax and/or additional fees). The system may also transmit an authorization request in a reserve amount. The reserve amount can be the first offer amount or a different amount (e.g. the asking price), such that the system may effectuate payment at a later date without further action by the buyer (e.g. the first offer amount plus applicable sales tax, shipping fee, and/or insurance fee).

The system may present the buyer's first offer to purchase an item to a seller via a seller interface. If the seller interface detects an acceptance of the first offer, the system can transmit a settlement request to a credit card processor to settle the authorization of the reserve amount, without additional action on the part of the buyer. By being able to effectuate payment without additional action on the part of the buyer, the system may encourage a seller to accept or respond to a first offer.

As explained herein, by collecting payment method information at the time the buyer makes a first offer, the system can transmit a request authorization of the payment method, for example a credit card, in a reserve amount to confirm that the buyer can effectuate payment should the seller accept the first offer or a later negotiated offer. An offer corresponding to an authorization of a buyer's payment method in a reserve amount may be referenced herein as a “guaranteed offer.” With the reserve amount authorized, the seller can accept the first offer with confidence that payment can be effectuated without further action on the part of the buyer or seller. In addition, the seller is assured the buyer has a serious interest in purchasing the product and therefore may be more willing to accept or counteroffer a buyer's first offer.

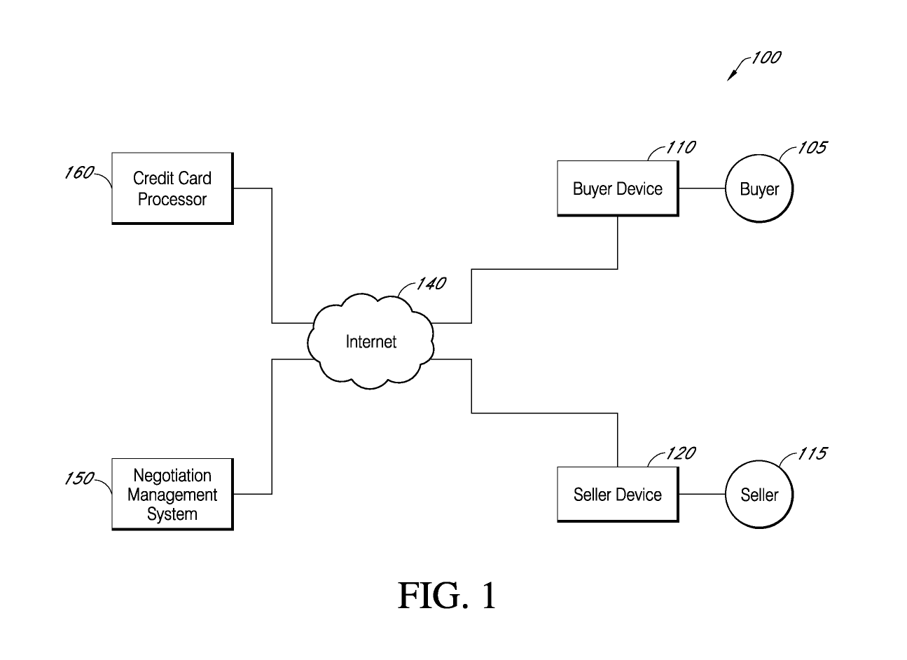

Referring first to FIG. 1, a block diagram of an embodiment of a purchasing system 100 is shown. A buyer 105 and seller 115 can interact with a negotiation management system 150 via respective devices 110 and 120 and a network, such as the Internet 140 or a wide area network (WAN), local area network (LAN) or other backbone. In some embodiments, the negotiation management system 150 may be made available to one or more buyers 105 and/or sellers 115 via an app (that can be downloaded to and executed on a portable electronic device) or a website. It will be understood that, although only one buyer 105 and one seller 115 are shown, purchasing system 100 can include different numbers of buyers 105 and/or sellers 115.

In some instances, the buyer 105 can log into a user account by using login information, and the login allows at least some account data to be availed to the buyer 105 and/or allows the buyer 105 to purchase or make an offer to purchase an item. Thus, e.g., the buyer 105 can provide a username and password, each of which is stored in an account. When the buyer 105 subsequently enters the username and password, other information from the account can be accessed and/or account-related action options (e.g., item purchasing options) can be enabled, payment method information may also be stored in the account. Similarly, in some embodiments, the seller 115 can log into a user account by using login information, and the login allows at least some account data to be availed to the seller 115, for instance data related to items the seller 115 has offered for sale, pending orders, completed orders, and/or additional account-related options.

The negotiation management system 150 can generate a seller item-transaction interface that can be dynamically modified to include an item-sale module, an offer-review module, and/or a counteroffer-module. The seller item-transaction interface can detect input related to an item offered for sale by a seller 115, including, for example, a photo of the item, a description of the item, a purchase price (or asking price) of the item, a shipping fee (or options buyer 105 may choose from for shipping service), any additional fees related to the sale of the item (known or to be determined), the seller/item's geographical location (e.g., a street address, or city and state identification), and/or other information related to the item and/or seller. Examples of additional fees may include a shipping fee for shipment of the item after sale, an insurance fee, or other additional fees.

As described further below, the negotiation management system 150 can use the input detected by the seller item-transaction interface to generate a buyer item-transaction interface that can be dynamically modified to include a query module, an item-presentation module, an item-purchase module, and an item-offer module, amongst others. The inputs detected by the buyer item-transaction interface can also influence what is presented at a seller item-transaction interface. The buyer 105 can view the buyer item-transaction interface via an app or webpage displayed on a buyer's device 110. The buyer item-transaction interface can present an item identification corresponding to one or more items offered for sale by a seller 115. The item identification can include an image of the item, a brief description of the item, a purchase price, and/or an indication the seller 115 is willing to negotiate the purchase price. The buyer item-transaction interface can present the item identification(s) in response to the buyer's query (e.g. query for type of item, price of an item, brand of an item, etc.) or without a query by the buyer. For example, the buyer item-transaction interface can present one or more item identification(s) without a query from the buyer 105, the item identification(s) corresponding to one or more popular items, newly offered items, items located in a particular city/state (e.g. the buyer's location), or varying combinations of item identifications.

The buyer's query can include explicit constraints of various item parameters, such as type of item (e.g. chair, desk, vase, jewelry, etc.), a location of the item (e.g. by city and state), seller's willingness to negotiate the purchase price (e.g. fixed purchase price or negotiable price), a shipping fee (e.g. shipping fee amount range, ability for seller to pick item up to avoid shipping fee), any additional fees (e.g. insurance), and/or item purchase price (or price range). Negotiation management system 150 may search an item records data store for item records corresponding to the constraints of the query received from the device 110 of the buyer 105 via the buyer-item transaction interface. The negotiation management system 150 can identify or return item records corresponding to the query (e.g. query results). In some embodiments, the negotiation management system 150 may perform a series of queries related to the various constraints and process the results to identify a subset of the results in order of a particular constraint (e.g. process the results in order of proximity to the buyer's location). In some instances, the various constraints may be selected by the negotiation management system 150 based on data associated with an account corresponding to the buyer 105 (e.g. the buyer's shipping address, price range of the buyer's prior purchases, item type of buyer's prior purchases, etc.).

Negotiation management system 150 can identify the query results and present the item identification(s) corresponding to one or more item records returned in the query results to the device 110 of the buyer 105 via the buyer item-transaction interface. The negotiation management system 150 may present the item identifications corresponding to the one or more item records in a particular order based on the query results (e.g. item identifications may be presented in order of relevance to the constraints of the query). If the negotiation management system 150 detects input corresponding to an indication the buyer 105 has selected a particular item identification a buyer interface module of the negotiation management system 150 can present a detailed item offering of the selected item identification. The detailed item offering can include, for example, an image of the item, a purchase price, a detailed description of the item, the item's dimensions, the item's location, the item's manufacturer, the item's time period of manufacture, the seller, and/or other information related to the item and/or the seller. The detailed item offering (or in some embodiments, the item identification) may also include an option to provide input that corresponds to a request to purchase the item at the asking price, an option to provide input that corresponds to an offer to purchase the item at a price other than the purchase price, and/or an option to provide input that corresponds to a request to contact the seller of the item.

The negotiation management system 150 can detect input received via the buyer item-transaction interface corresponding to a request to make a first offer for purchase of an item. The negotiation management system 150 can further detect input received at an item-offer module sufficient to process a purchase of the item, including a first offer amount, identification of a payment method (e.g. credit card, debit card, online payment account), payment method information (e.g., a credit card number, credit card expiration date, CVV/CVC code, credit card billing address, or information corresponding to an online payment account) and shipping address, and/or other information required to process a payment using the payment method. For example, in some embodiments, the negotiation management system 150 detects input received at an item-offer module sufficient to make a payment by ACH transfer directly from a bank account associated with the buyer 105. In some embodiments, the negotiation management system 150 may detect input received at an item-offer module corresponding to a request to purchase an item and may retrieve payment method information from data associated with the buyer's account. The negotiation management system 150 can transmit an authorization and/or settlement request to a credit card processor 160 to authorize and/or settle one or more charges of the payment method associated with the buyer 105 through a network, such as the Internet 140. In some embodiments, the credit card processor 160 may be altered to be capable of completing payment using other payment techniques, including ACH transfers, online payment accounts (e.g. PayPal™), value cards, or other electronic payment methods.

It can be appreciated that in some embodiments, before transmitting an authorization or settlement request to the credit card processor 160 the negotiation management system 150 can transmit a fraud detection request to a credit card fraud detection processor. If the negotiation management system 150 receives a communication from the credit card fraud detection processor that indicates the transaction is believed to be fraudulent the negotiation management system 150 can create a notification, alert, or other suitable method for flagging the transaction for review (e.g. manual review). In some embodiments, if following a review input is received by the negotiation management system 150 (e.g. by an individual inputting data to an interface) corresponding to an indication that the transaction is not fraudulent; the negotiation management system 150 can transmit an authorization and/or settlement request to the credit card processor 160. In some embodiments, if following a review input is received by the negotiation management system 150 corresponding to an indication that the transaction is fraudulent; the negotiation management system 150 can cancel (or terminate) the transaction prior to sending a request to authorize the payment method. The negotiation management system 150 can also generate a notification to the buyer 105 indicating the transaction was cancelled due to suspected fraud.

The negotiation management system 150 can generate and transmit notifications to the seller 115. The notification can be viewed by the seller 115 using the seller device 120. The notification may include the first offer (the first offer may include a first offer amount) and an option for responding to the first offer (e.g. an option to accept the first offer, reject the first offer, or counteroffer the first offer). Similarly, the negotiation management system 150 can also generate and transmit notifications to the buyer 105. The notification can be viewed by the buyer 105 using the buyer device 110. For example, the notification can identify an acceptance from the seller, a rejection from the seller, or a counteroffer from the seller. A “counteroffer” can be an offer (e.g. an offer amount) presented in response to a pending offer. A notification identifying a counteroffer from a buyer 105 or seller 115 may also include an option for responding to the counteroffer (e.g. an option to accept the counteroffer, reject the counteroffer or provide a counteroffer to the seller 115). The ongoing negotiation between a buyer 105 and a seller 115 can be facilitated by the negotiation management system 150 by generating and/or transmitting notifications that include the currently pending offer and an option to respond to the currently pending offer. The notifications can be presented by the seller item-transaction interface and/or the buyer item-transaction interface and viewed by the buyer 105 and/or seller 115 using the buyer device 110 and/or seller device 120. The negotiation management system 150 can also detect input corresponding to a response from the buyer 105 or seller 115 respectively. The negotiation management system 150 may also update an item record (or an order status associated with an item record) to reflect the status of the negotiation (e.g. first offer pending, first counteroffer pending, Nth counteroffer pending, accepted offer). In some embodiments, the negotiation management system 150 may update an order record associated with the transaction (or order) to reflect the status of the negotiation. In some embodiments, the buyer 105 and/or seller 115 can view the notification using the buyer device 110 and/or seller device 120 by logging into an account associated with the buyer 105 and/or seller 115. The notification can also be presented to the buyer 105 and/or seller 115 via an app, webpage, email, SMS message, MMS message, or other suitable communication.

When during the iterative offer/counteroffer process of a negotiation, the negotiation management system 150 detects input corresponding to an acceptance of a pending offer (may be referred to herein as an “accepted offer”), the negotiation management system 150 can also process a payment of an accepted offer amount corresponding to the accepted offer. As described in more detail below, depending on the accepted offer amount as compared to a reserve amount taken on the payment method, the negotiation management system 150 may be able to effectuate payment of the accepted offer amount without requiring additional input from the buyer 105. For example, in instances where the reserve amount taken on the payment method is equal to or greater than the accepted offer amount, the negotiation management system 150 may effectuate payment by transmitting a settlement request associated with the authorization hold. As described in more detail below, where the accepted offer amount is greater than the reserve amount the negotiation management system 150 may effectuate payment in one or more piecemeal payment processes.

A credit card or debit card payment that is signature based, i.e. not a pin purchase, can include two steps, (1) authorization and (2) settlement. In the first step, when a debit card or credit card is presented for payment, the merchant's acquirer or a credit card processor can verify that the account is valid and that sufficient funds are available to cover the transaction amount or an amount greater than or less than the transaction amount. This step is known as authorization, placing an authorization hold, preauthorization, or preauth. The second step, settlement, can take place at a later time, for instance at the end of the day in a single batch transfer. At the settlement step the merchant can submit the authorized transactions (or authorizations) to the acquirer or credit card processor for finalization. It is at the settlement step that the “charge” is shows up on the user's credit card statement and payment is effectuated. An authorization hold that has not been settled remains until the hold is either settled or until the hold “falls off” after a certain amount of days, as determined by the credit card acquirer. Authorization holds on debit cards can “fall off” from between about 1-5 days after the transaction date. Until the authorization hold “falls off” the debit card the amount of the authorization hold can be held against the balance of the card. The authorization hold for credit cards can vary by bank and may last as long as 30 days. The authorization hold amount for a credit card can be reflected on a buyer's credit card statement as a pending charge and can be held against the credit limit of the credit card. By requesting an authorization hold on the buyer's credit card in the reserve amount at the time the first offer is made the seller 115 can be confident that the first offer is “guaranteed.” That is, the seller 115 can be confident that the first offer amount offered by the buyer 105 can be collected from the buyer 105 should the seller 115 accept the first offer because the payment method information has been collected and the payment method has been preauthorized by the negotiation management system 150 in a reserve amount. With the payment method preauthorized in the reserve amount no further action is required on the part of the buyer 105 for payment to be made to the seller 115 should the seller 115 accept the first offer.

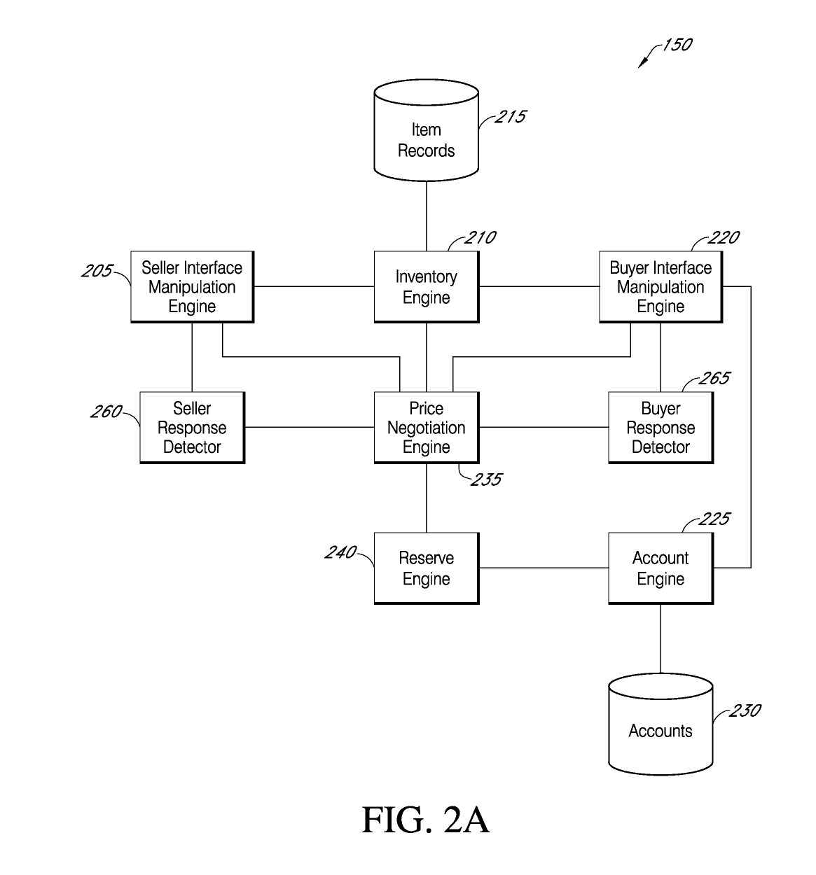

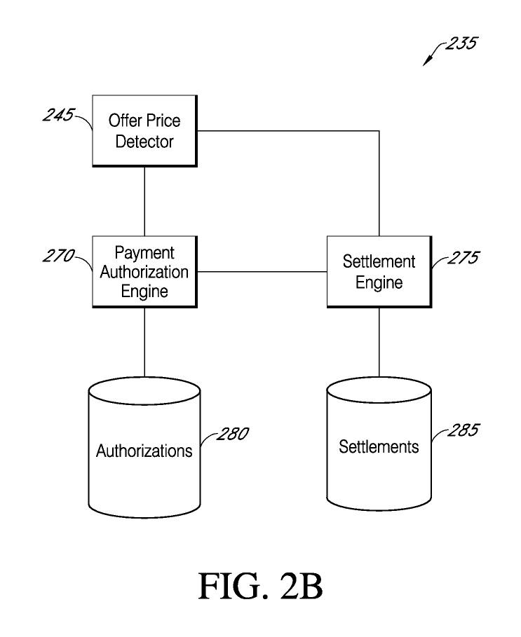

FIG. 2A shows a block diagram of an embodiment of the negotiation management system 150. The negotiation management system 150 can be, in part or entirely, in a cloud. In some instances, at least part of the negotiation management system 150 is present on a device, such as a buyer device 110 and/or a seller device 120. In some instances, the negotiation management system 150 can be distributed (e.g., across devices and/or the cloud). It will be appreciated that, while FIG. 2A identifies particular components as belonging to the negotiation management system 150 in some embodiments, a component can be present in a separate system.

The negotiation management system 150 includes a seller interface manipulation engine 205 which can detect input corresponding to item offer information about an item offered for sale (e.g., input provided by a seller 115). The input can correspond to a file uploaded by the seller 115 or data input manually by the seller 115. The seller 115 can manually input item offer information via an app or webpage that includes an item offer module. The item offer module can include a graphical user interface (GUI) that can identify various fields for a seller 115 to input item offer information related to the item offered for sale (e.g., a brief description field, a purchase price field, a brand identification field, a number of items available field). In some embodiments, one or more fields may be required while other fields may be optional. The item offer information can include information related to the item type, style, size, time period, data of manufacture, condition, materials, price, if price is negotiable, shipping fee, insurance fee, current geographic location, and/or item return policy. The seller interface manipulation engine 205 can communicate with an inventory engine 210 which aggregates the item offer information for each item, generates an item record for each item that includes the aggregated item offer information, and stores each item record in an item records data store 215. The item record can also include seller information (e.g. seller location, seller name, and/or other seller related information) and/or a reference numeral or reference identifier that may be used to identify the item record.

The inventory engine 210 can send data corresponding to one or more item records to a buyer interface manipulation engine 220 which can present an item identification corresponding to select data from an item record(s) (e.g. item image, brief description, purchase price) to the buyer 105. In some embodiments, the buyer interface manipulation engine 220 can present the item identification(s) without a query by the buyer. In some embodiments, the buyer interface manipulation engine 220 can present the item identification(s) in response to the buyer's query. For example, but not limited to, a query for a type of item (e.g. a chair, a desk, a vase, or other item type) or without a query by the buyer. For example, the buyer interface manipulation engine 220 interface can present the item identification(s) corresponding to one or more popular items, newly offered items, or items located in a particular city. The item identification(s) can be presented to one or more buyers via an app, webpage, email, SMS message, MMS message, etc.

In some embodiments, the buyer interface manipulation engine 220 can detect input corresponding to a buyer's query that includes one or more query terms from a query module of the buyer item-transaction interface (e.g. query term can include a brand name, or any other item property). The buyer interface manipulation engine 220 can communicate the query to the inventory engine 210. The inventory engine 210 can search the item records data store 215 for items corresponding to the query term(s) and locate query results (e.g. item records corresponding to the query term(s)). The inventory engine 210 can send item record data corresponding to the query results to the buyer interface manipulation engine 220. The buyer interface manipulation engine 220 can present an item identification corresponding to each of query results to the buyer 105. The item identification can include, for example, but not limited to, an image of the item, a brief description of the item, and a purchase price.

In some embodiments, the inventory engine 210 can identify a subset of the query results that include data or characteristics matching select data or characteristics associated with account data corresponding to a particular buyer (e.g., items located within a pre-set distance of the buyer's shipping address). For example, the inventory engine 210 can identify which of the query results include item(s) located within 10 miles of the shipping address of the buyer 105 and the buyer interface manipulation engine 220 can present those item identifications first before the other query results. The inventory engine 210 can receive data associated with the buyer 105 or the seller 115 (e.g. the buyer's shipping address, seller's location, etc.) from an account engine 225.

If the buyer interface manipulation engine 220 detects input corresponding to a buyer's selection of a particular item identification, the buyer interface manipulation engine 220 can generate a detailed item offering of the selected item identification that includes additional information associated with the item record. For example, the presentation of a detailed item offering corresponding to an antique Louis XIV dining table offered for sale can include an image of the dining table, an identification of the dining table as a Louis XIV style table, a manufacturing date listed as ‘circa 1875’, the dining table's measurements, the seller's location (which in some instances may indicate the item's location) as San Francisco, Calif., a flat shipping fee of $500 for shipping anywhere within the United States, and/or a reference number associated with the item record. The buyer interface manipulation engine 220 can also present an option for the buyer 105 to provide input corresponding to a request to purchase the item at the asking price (e.g. a GUI button labelled “purchase”). The buyer interface manipulation engine 220 can also present an option for the buyer 105 to provide input corresponding to a request to contact the seller 115 and/or make a first offer to purchase the item. The first offer can include a first offer amount that is different than the asking price of the item.

A buyer interface manipulation engine 220 can detect input corresponding to a buyer request to make a first offer to purchase the item corresponding to the item identification (or detailed item offering). The buyer interface manipulation engine 220 can present an interface to a buyer 105 that prompts the buyer 105 to provide a first offer and payment method and payment method information. The first offer can include a first offer amount. The buyer interface manipulation engine 220 can detect input corresponding to the first offer (including the first offer amount), the buyer's payment method and payment method information. For example, the buyer interface manipulation engine 220 can detect input identifying the buyer's credit card number, credit card CVV/CVC number, credit card expiration date, credit card billing address, shipping address, and approval to authorize a reserve amount on the payment method. The buyer interface manipulation engine 220 can also communicate data corresponding to the buyer's payment method and payment method information, and/or shipping address to the account engine 225 for generation of an account associated with the buyer 105, the information associated with the buyer account can be stored in an accounts data store 230. In some instances the buyer interface manipulation engine 220 can retrieve information associated with the buyer's account, such as, for example, the buyer's payment method, payment method information and the buyer's shipping address from the account engine 225.

The account engine 225 of negotiation management system 150 can generate accounts for buyers and/or sellers, and store accounts in the accounts data store 230. The account engine 225 can identify accounts for a particular buyer and/or seller and/or identify accounts with particular data matching parameters (e.g. a buyer 105 that has previously purchased or identified an interest in a particular time period, an item's geographic location, or item type). The account engine 225 can also store login information which allows the account engine 225 to retrieve account information and/or make account modifications upon receiving login information matching a particular account. An account for a buyer 105 or a seller 115 can be generated based on information provided by the buyer 105 or the seller 115 and/or based on automatically detected data. For example, a buyer 105 can provide input that identifies their name, email address, mailing address, billing address, payment method, payment method information, items types of interest (e.g. desks, jewelry, art, etc.), time periods of interest, and/or contact information (e.g. email and/or telephone number). In some instances, the account engine 225 can store data related to the prior purchases of the buyer 105. The operating system, make and model, and software capabilities of the buyer device 110 and seller device 120 can be automatically detected. In addition, in some embodiments, an orders data store can store order records corresponding to pending, completed, and/or cancelled orders (or transactions). The order records can include data corresponding to the item(s), the buyer 105, the seller 115, the status of the order (e.g. pending, completed or cancelled), and other information related to the order. In some embodiments, the account engine 225, inventor engine 210, and/or other engines of the negotiation management system 150 can access the order data store.

In an instance in which the buyer interface manipulation engine 220 detects input corresponding to a first offer for purchase, the buyer interface manipulation engine 220 can detect and communicate input corresponding to the first offer to the price negotiation engine 235. The price negotiation engine 235 can detect a first offer amount included in the first offer and can communicate the offer first amount to a reserve engine 240. The reserve engine 240 can determine a reserve amount. The reserve amount can be the first offer amount, a sum of the first offer amount plus additional fees (e.g. sales tax, a shipping fee and/or an insurance fee). In some embodiments, the additional fees may be known at the time the reserve amount is calculated. In some embodiments, the additional fees may be estimated or a set additional fee may be utilized.

The reserve engine 240 can communicate with the price negotiation engine 235 to retrieve additional data related to the item record corresponding to the first offer such as fees known at the time the first offer was received (e.g. a shipping fee specified by the item record). The reserve engine 240 can also communicate with the account engine 225 to retrieve data related to the buyer 105 and/or the seller 115 that may be used in estimating or calculating additional fees such as sales tax, a shipping fee, and/or an insurance fee. For example, the reserve engine 240 can calculate the sales tax that would be due based on the buyer's shipping address and the first offer amount.

In some instances, the reserve engine 240 can estimate unknown additional fees (e.g. sales tax, shipping fee, and/or insurance fee) utilizing data associated with the buyer's account, the seller's account, and/or the item record. For example, the reserve engine 240 can consider the seller and/or buyer's location, the seller's prior shipping and/or insurance fees, the type of item being shipped (e.g. jewelry or dining room table), and/or the item's size, in estimating an unknown fee. The reserve engine 240 can also determine a flat shipping estimate and/or flat insurance estimate in the calculation of the reserve amount irrespective of the buyer 105 and seller 115 account details. For example, the reserve engine 240 can include a flat shipping fee estimate that is a percentage of the asking price of the item, or a flat shipping fee estimate for all products of a certain type (e.g. desks have a flat shipping fee estimate of $500), or other suitable methods of estimating a flat shipping fee. In some embodiments a flat shipping fee and/or flat insurance fee can be included in the calculation of the reserve amount where the flat shipping fee and/or flat insurance fee amounts are selected by the reserve engine 240 (e.g. a $150 shipping fee and/or $50 insurance fee can be used to calculate the reserve amount).

The reserve engine 240 can communicate the reserve amount to the price negotiation engine 235. The price negotiation engine 235 can communicate the reserve amount to the buyer interface manipulation engine 220 which can generate a notification including an option or request to approve the reserve amount. In other instances the reserve engine 240 can communicate the reserve amount directly to the buyer interface manipulation engine 220. The buyer interface manipulation engine 220 can detect input corresponding to the buyer's selection to approve the reserve amount and can communicate the approval to the price negotiation engine 235. In some embodiments, the buyer 105 can have previously agreed to authorize the reserve amount calculated by the reserve engine 240 for any future first offers, for example, at the time the buyer 105 created an account with the website.

As shown in FIG. 2B, that depicts a block diagram of an embodiment of the price negotiation engine shown in FIG. 2A, the price negotiation engine 235 can include an offer price detector 245, a payment authorization engine 270, and/or a settlement engine 275. The payment authorization engine 270 can transmit an authorization request to a credit card processor 160 via a network, such as a credit card network or the Internet, in the reserve amount for the payment method associated with the buyer 105. The payment authorization engine 270 can also receive a confirmation from the credit card processor 160 that the authorization request was approved in the reserve amount. The confirmation can include a confirmation number. The payment authorization engine 270 can also store the confirmation, including the confirmation number, in an authorizations data store 280. By having the payment authorization engine 270 transmit a request for authorization of the payment method in the reserve amount it is possible to effectuate payment by settling the authorization of the payment method in a total amount due after the final calculation of any additional fees such as sales tax, shipping fee, and/or other additional fees.

The price negotiation engine 235 can notify the buyer interface manipulation engine 220 of an event (e.g. authorization of the payment method in the reserve amount, receipt of a counteroffer, receipt of an acceptance). The buyer interface manipulation engine 220 can generate a notification to the buyer 105 that identifies the event. The notification can also include an option to respond to the event reported, including, but not limited to, an option to accept, reject, or counteroffer a pending offer. The price negotiation engine 235 can also notify the seller interface manipulation engine 205 of an event (e.g. receipt of first offer, acceptance of a pending counteroffer, confirmation of a buyer's payment). The notification can also include an option to respond to the event identified. For example, the notification can include an option to accept, reject, or counteroffer the pending offer. In some embodiments the buyer 105 and/or seller 115 can access their respective notifications via an app, webpage, email, SMS message, MMS message, voice message, etc.

A seller response detector 260 and buyer response detector 265 can detect an input corresponding to a response to a pending offer (e.g. a first offer or a counteroffer) from a seller 115 or a buyer 105, respectively. For example, the response detector 260, 265 can detect input corresponding to an acceptance, a rejection, or a counteroffer. Either of the seller response detector 260 or the buyer response detector 265 can communicate the response (e.g. an acceptance, a rejection, or a counteroffer) to the price negotiation engine 235. The price negotiation engine 235 can determine what action is to be taken following the response (e.g. communicate the identification of the response to the buyer interface manipulation engine 220 or seller interface manipulation engine 205, transmit a request to settle an authorization hold, and/or transmit a request to charge a payment method).

When either the seller response detector 260 or the buyer response detector 265 detects an input corresponding to an acceptance of a pending offer (or an “accepted offer”), the respective response detector 260, 265 can communicate the acceptance to the price negotiation engine 235. The price negotiation engine 235 can include an offer-price detector 245 that can detect the pending offer amount (or “accepted offer amount”). The price negotiation engine 235 can determine a total amount due to complete the purchase of the item(s) (e.g. an amount that is the sum of the accepted offer amount, sales tax, shipping fee, and/or insurance fees). In some instances, the price negotiation engine 235 can access the inventory engine 210 and the account engine 225 to retrieve information used to calculate the total amount due (e.g., buyer 105 and seller 115 account information used to calculate the sales tax, shipping fee, and/or insurance fee).

The price negotiation engine 235 can also determine if the total amount due is less than or equal to the reserve amount that was previously authorized. If the price negotiation engine 235 determines that the total amount due is less than or equal to the reserve amount, the settlement engine 275 can transmit a settlement request to the credit card processor 160. The settlement engine 275 can also detect a communication from the credit card processor 160 confirming that the authorization hold on the payment method was settled in the total amount due. The settlement engine 275 can store the confirmation of settlement in a settlements data store 285. The price negotiation engine 235 can also communicate with the inventory engine 210 to update the item record to reflect the total amount due was paid.

If the price negotiation engine 235 determines that the total amount due is greater than the reserve amount then the price negotiation engine 235 can engage in a piecemeal settlement of the total amount due. In some instances, the price negotiation engine 235 can transmit a request to authorize and settle a new charge of the payment method in the total amount due. The difference between the total amount due and the reserve amount is defined as a balance due amount. When a piecemeal settlement is required, the price negotiation engine 235 can communicate with the buyer interface manipulation engine 220 which can generate a notification to the buyer 105 requesting approval to charge the payment method in the total amount due, or in some instances, approval to charge the payment method in the balance due amount. The buyer interface manipulation engine 220 can detect an input indicating the buyer's approval from the buyer device 110. In some embodiments, the buyer 105 can have an option to select the payment method used to authorize the reserve amount, a payment method associated with the account of the buyer 105, or can provide payment method information corresponding to a new payment method.

In one instance, the payment authorization engine 270 can transmit a request to the credit card processor 160 to settle the authorization hold on the payment method in the reserve amount. In that instance, the payment authorization engine 270 can also transmit an authorization request to the credit card processor 160 of the payment method in the balance due amount. The payment authorization engine 270 can also receive a communication from the credit card processor 160 confirming the authorization of the payment method in the balance due amount. The settlement engine 275 of the price negotiation engine 235 can transmit a settlement request to the credit card processor 160 requesting settlement of the payment method in the balance due amount. In such an instance, the buyer's payment would show on the buyer's credit card statement as a first charge in the reserve amount and a second charge in balance due amount.

In some instances, the price negotiation engine 235 can divide the total amount due into various piecemeal charges, for example, but not limited to, charges reflecting (1) the agreed upon sales price plus sales tax, (2) the shipping fee, and/or (3) the insurance fee. The price negotiation engine 235 may also apply the reserve amount to various portions of the total amount due. For example, in some embodiments the authorization hold in the reserve amount may only be settled as payment for the price of the item plus sales tax. If an additional fee (e.g. a shipping fee) is added during the course of the transaction, the additional fee can be collected as a balance due amount.

In some instances, the price negotiation engine 235, upon receiving confirmation that the buyer has approved a charge of the payment method in the total amount, transmits an authorization request to the credit card processor 160 of the payment method in the total amount due. Upon receiving a confirmation from the credit card processor 160 confirming the authorization of the payment method in the total amount due, the settlement engine 275 can transmit a settlement request to the credit card processor 160 requesting settlement of the payment method in the total amount due, once the authorization has been settled in the total amount due a single charge in the total amount due would appear on the buyer's credit card statement. The authorization hold of the reserve amount can be allowed to fall off and would not appear as a charge of the buyer's credit card.

The price negotiation engine 235 may include an optional counter engine that counts the number of notifications containing counteroffers that are generated during an item's negotiation. In such an instance, after a pre-set number of notifications containing counteroffers have been reached, the price negotiation engine 235 may limit the options for responding to a counteroffer to include an acceptance or a rejection of the pending counteroffer. This places a limit on the duration of the negotiation for purchase of an item. In some instances, the seller 115 can determine the pre-set number value. In some embodiments, the price negotiation engine 235 can include a clock engine that terminates the negotiation after a pre-set amount of time has passed during a single offer/counteroffer iteration or some other pre-set limit. Similarly, if a rejection is received, the price negotiation engine 235 can terminate the negotiation and update the status of the item negotiation to reflect that the negotiation has been terminated. In some embodiments, if a buyer 105 or seller 115 does not respond to a pending offer within a pre-set amount of time (amount of time can be selected by the system, buyer, and/or seller), the price negotiation engine 235 can terminate the negotiation.

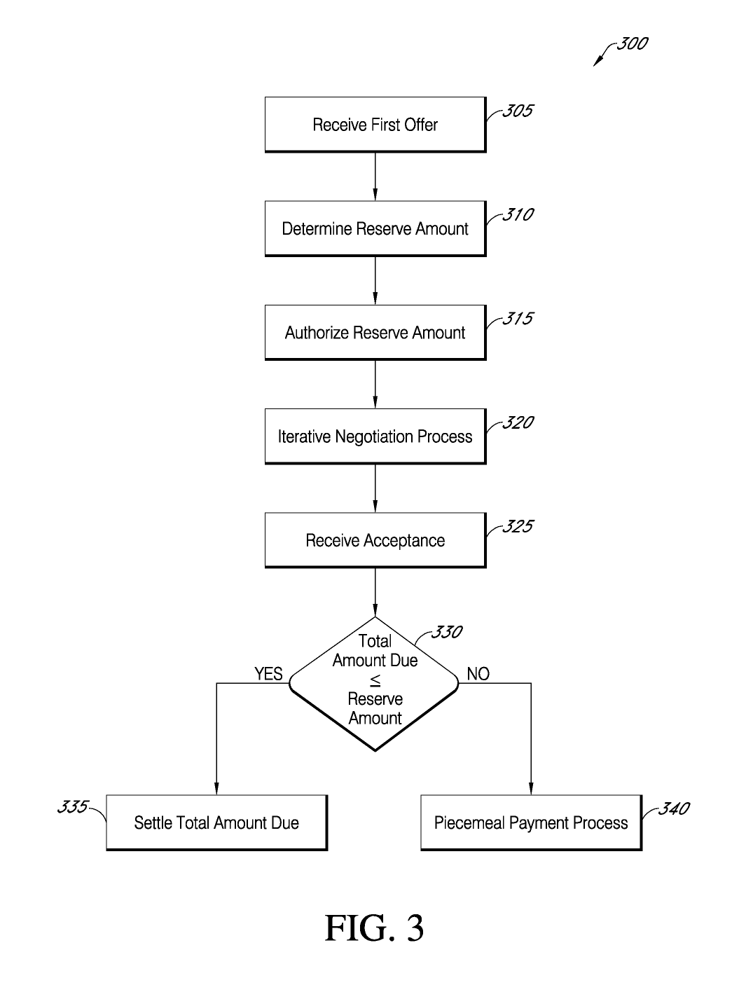

FIG. 3 illustrates a flowchart of an embodiment of a process 300 for negotiating the purchase of an item. The buyer interface manipulation engine 220 can present one or more item identifications via a webpage or app. The buyer interface manipulation engine 220 can detect input corresponding to a buyer's selection of a particular item identification. In response to detecting the input corresponding to the buyer's selection, the buyer interface manipulation engine 220 can present a detailed item offering corresponding to the selected item identification.

The detailed item offering can include a purchase amount and/or an indication that the seller of the item is willing to negotiate the purchase price of the item. The detailed item offering can also include an option to purchase the item (at the asking price) or provide a first offer to purchase the item. The process 300 begins at block 305, where the buyer interface manipulation engine 220 detects input corresponding to a selection of an option to provide a first offer to purchase the item from a buyer device 110. The input can be entered by a buyer 105 or can correspond to a selection of an option (e.g. selecting an option to make a first offer of 90% of the purchase price). The first offer can include a first offer amount, payment method (credit card, debit card), payment method information (e.g. credit card number, CVV/CVC code, expiration date, billing address), a shipping address, and/or any additional information relevant to the offer and/or to be used to process a payment and complete the sale of the item.

The reserve engine 240 calculates a reserve amount to authorize on the payment method at block 310. Reserve engine 240 can calculate a reserve amount using information such as the first offer amount, the asking price, the buyer's shipping address, and/or information related to the item and/or the seller 115. For example, the reserve engine 240 can estimate a shipping fee based on the item's location and the buyer's shipping address. In another instance, the reserve engine 240 can estimate a shipping fee based on the shipping fee quoted in other sales completed by the seller 115.

The reserve engine 240 can communicate the reserve amount to the payment authorization engine 270. At block 315 the payment authorization engine 270 can transmit an authorization request to a credit card processor 160 to authorize the payment method in the reserve amount. The payment authorization engine 270 can transmit the request using a network, such as a credit card network or the Internet. The payment authorization engine 270 can also receive a communication from the credit card processor 160 confirming that the reserve amount is authorized. At block 320, the price negotiation engine 235 can engage in what can be an iterative negotiation process in which the buyer 105 and seller 115 can negotiate the purchase of the item by way of the price negotiation engine 235. For example, the first offer submitted by buyer 105 using buyer device 110 can be identified in a notification sent to the seller device 120 by the price negotiation engine 235. The seller response detector 260 can detect a response to the notification from the seller 115 and determine whether the response indicates the first offer was accepted, rejected or if a counteroffer was received. Notifications containing counteroffers from the buyer 105 and/or the seller 115 can continue to be generated and transmitted to the buyer 105 and/or the seller 115 until a response is detected that corresponds to a rejection of the pending offer (or “a pass”), an acceptance of the pending offer, or the negotiation times out (e.g. based on a pre-set time limit for the negotiation, a pre-set time limit without a response detected or a pre-set number of iterations).

At block 325, one of the seller response detector 260 or the buyer response detector 265 determines that an input corresponding to an acceptance of the pending offer amount has been received (hereinafter the “accepted offer amount”). The respective response detector 260, 265 sends a communication to the price negotiation engine 235 indicating an acceptance has been received. The communication can also include additional information corresponding to the acceptance (e.g. buyer and/or seller account information, the accepted offer amount, and/or item record information).

The price negotiation engine 235 determines if the total amount due is less than or equal to the reserve amount at block 330. The total amount due can be a sum of the accepted offer amount and any additional fees such as sales tax, shipping fee, insurance fee. In some embodiments, one or more additional fees can be negotiated using the negotiation management system 150, for example but not limited to a shipping fee. The additional fees can be negotiated parallel with the purchase price negotiation or together with the purchase price negotiation. In some embodiments, the price negotiation engine 235 may determine if the total amount due is less than or equal to some pre-set percentage of the reserve amount (percentage could be greater than 100 percent if the credit card processor 160 will allow settlement in an amount greater than the reserve amount).

In instances in which at block 330 the price negotiation engine 235 determines the total amount due is less than or equal to the reserve amount, then the price negotiation engine 235 engages in a settlement process corresponding to the authorization of the payment method. For example, the settlement engine 275 of the price negotiation engine 235 can transmit a settlement request to credit card processor 160 to settle an authorization of the payment method in the total amount due. The settlement process completed at block 335 may not require any additional authorization, approval, and/or additional information from the buyer to complete the settlement process and thereby complete the payment collection for the item.

In instances in which at block 330 the price negotiation engine 235 determines that the total amount due is greater than the reserve amount then the price negotiation engine 235 engages in a piecemeal payment process at block 340. The piecemeal payment process at block 340 can include the price negotiation engine 235 transmitting a settlement request to the credit card processor 160 to settle the payment method in the reserve amount and requesting authorization from buyer 105 to complete a new charge (e.g. an authorization and settlement) on the payment method in the balance due amount (e.g. the amount difference between the reserve amount and the total amount due). In some instances, at block 340 the price negotiation engine 235 can generate a notification including a request for the buyer's approval of a new charge of the payment method in the total amount due. In some instances, a variety of other combinations of settlement corresponding to the previously authorized charge and new charges can be transmitted to complete payment of the total amount due. For example, the preauthorized reserve amount could be allocated to the portion of the total amount due corresponding to the item's purchase (as opposed to a shipping fee) and a new charge could be authorized corresponding to the additional fees (e.g. shipping, insurance, etc.).

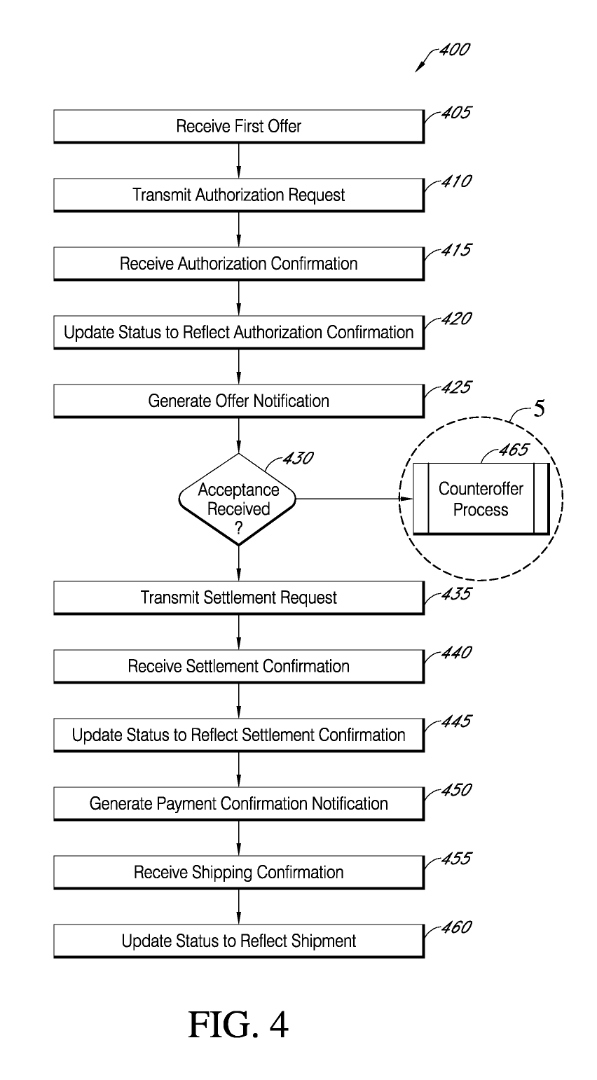

FIG. 4 illustrates a flowchart of an embodiment of a process 400 for negotiating the purchase of an item. Process 400 begins at block 405, where buyer interface manipulation engine 220 detects input corresponding to an option to provide a first offer from a buyer device 110. The first offer can include a first offer amount and additional offer data. For example, the first offer can include a first offer amount and information regarding whether the buyer requires shipment of the item or if the buyer can pick-up the item. In some embodiments, the first offer amount can include shipping and/or insurance fees. In some embodiments, the first offer amount can be solely for the item, and additional fees (e.g. shipping and/or insurance) can be subsequently and/or separately negotiated. The input can be entered by a buyer 105 or can correspond to a selection of an option (e.g. selecting an option to make a first offer of 90% of the asking price). The first offer can include a first offer amount, payment method, payment method information (e.g. credit card number, credit card CVV/CVC code, credit card expiration date, credit card billing address), a shipping address, and/or any additional information used to process a payment and complete the sale of the item.

The reserve engine 240 can calculate a reserve amount. In some embodiments, the reserve amount can correspond to a total amount due should the first offer be accepted by the seller (e.g. can include additional fees such as tax, shipping, and/or insurance). In some embodiments, the reserve amount can correspond to the sum of the asking price and any additional fees (known or estimated). The reserve engine 240 can transmit the reserve amount to the price negotiation engine 235. At block 410 the payment authorization engine 270 of the price negotiation engine 235 can transmit an authorization request to a credit card processor 160 via a network to authorize the payment method in the reserve amount. The request can include the payment method information, the reserve amount, an identification of the buyer 105 and seller 115, and/or the item record corresponding to the item being negotiated. At block 415 the payment authorization engine 270 can receive a communication from the credit card processor 160 corresponding to a confirmation that the reserve amount has been authorized. At block 420 the price negotiation engine 235 can notify the inventory engine 210 of the authorization of the reserve amount. The inventory engine 210 can update the item record to reflect that the first offer has been received and the reserve amount has been authorized. In some embodiments, when the item record reflects that the reserve amount has been authorized, the item record will not be returned in response to a query performed by another buyer. In some embodiments, the seller 115 can log in to their account and view the item records associated with a pending offer (or counteroffer, or acceptance, etc.).

The price negotiation engine 235 can communicate with the seller interface manipulation engine 205 to generate a notification viewable by the seller 115 on the seller device 120. The notification can include information corresponding to the first offer, including the first offer amount and confirmation that the reserve amount has been authorized. The notification can also include an option to respond to the first offer by accepting, rejecting, or counteroffering the first offer amount. In some embodiments, the notification can also include an option to request an additional fee from the buyer 105 (e.g. a shipping fee and/or an insurance fee).

The seller response detector 260 can determine at block 430 if an acceptance of the first offer was detected. If at block 430 the seller response detector 260 determines that an acceptance of the first offer was received, the settlement engine 275 can transmit to the credit card processor 160 a request to settle the authorization in the reserve amount at block 435. The settlement engine 275 can detect a communication from the credit card processor 160 corresponding to a confirmation of the settlement of the payment method in the reserve amount at block 440. The settlement engine 275 can notify the price negotiation engine 235 that a communication corresponding to a confirmation of settlement has been detected. The price negotiation engine 235 can instruct the inventory engine 210 to edit the item record to reflect that purchase of the item has been completed at block 445. In some embodiments, the item record may no longer be returned in response to a query once the item record indicates the item has been purchased. In some embodiments, the order record associated with the negotiation between the buyer 105 and the seller 115 may be updated to reflect the order (or transaction) is complete. In some embodiments, when an acceptance of the first offer (or a later offer or counteroffer) is detected, all other pending (or open) orders (or transactions) of the item can be terminated by the price negotiation engine 235. In some embodiments, the price negotiation engine 235 updates the item record or order record and/or terminates all other pending orders when a communication corresponding to a confirmation of settlement has been detected.

The price negotiation engine 235 can also communicate to the seller interface manipulation engine 205 that the settlement has been confirmed. The seller interface manipulation engine 205 can generate a notification that the seller 115 may view on the seller device 120 that identifies that the buyer's payment method has been settled in the reserve amount at block 450. The notification can also include an option to confirm or identify when the item has been shipped. In some instances, the price negotiation engine 235 can also communicate with the buyer interface manipulation engine 220 which can generate a notification that the buyer 105 may view on the buyer device 110. The notification can report that the first offer was accepted and the buyer's payment method was settled in the reserve amount.

At block 455 the seller response detector 260 can detect input corresponding to the seller's indication that the item has been shipped. The seller response detector 260 can notify the price negotiation engine 235 that it has detected input corresponding to an indication that the item has been shipped. The price negotiation engine 235 can instruct the inventory engine 210 to update the item record to reflect that the item has been shipped at block 460. In some instances the buyer response detector 265 can generate a notification to the buyer's device 110 indicating the item has been shipped.

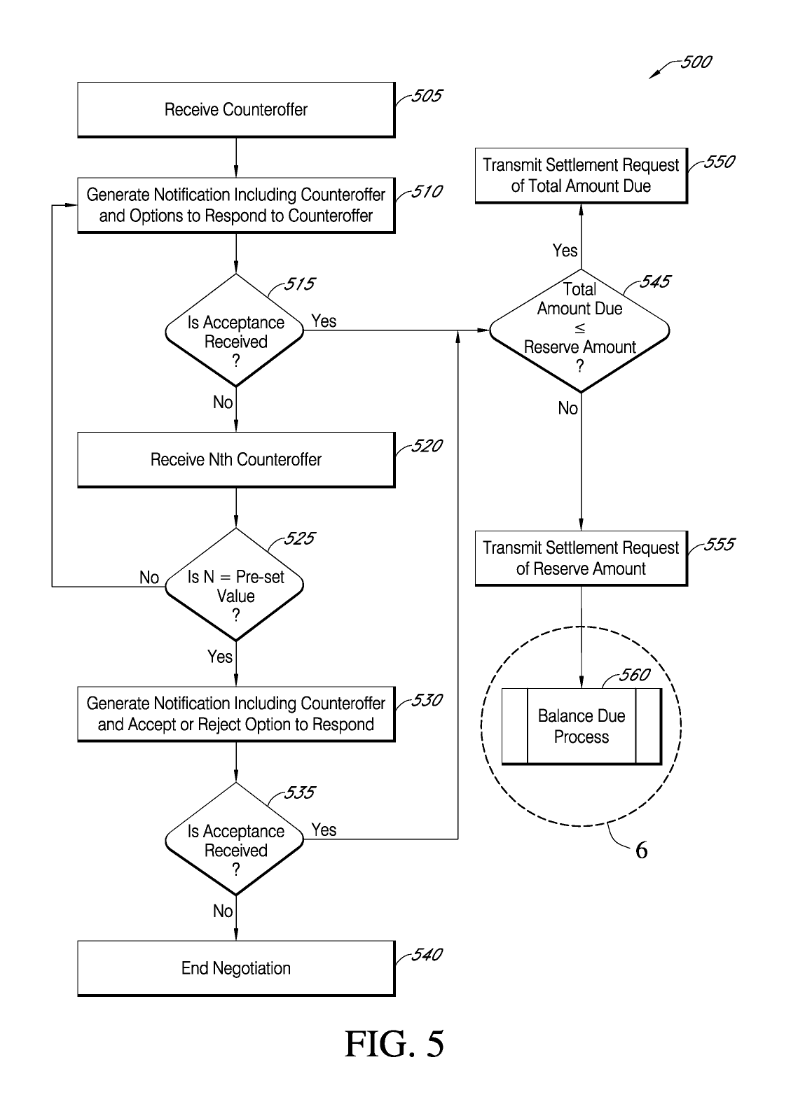

At block 430, if the seller response detector 260 detects that the seller has counteroffered, the system proceeds to a counteroffer process at block 465. An exemplary counteroffer process is depicted in the flowchart of FIG. 5. At block 505 one of the seller response detector 260 or buyer response detector 265 detects input corresponding to an Nth counteroffer (e.g. a 1^{st} counteroffer, 2^{nd} counteroffer, etc.), the Nth counteroffer including, for example, a counteroffer amount. For example, the buyer response detector 265 can detect input corresponding to a response from the buyer that includes a counteroffer having a counteroffer amount. The buyer response detector 265 can communicate the counteroffer to the price negotiation engine 235 or directly to the seller interface manipulation engine 205.

At block 510, one of the interface manipulation engines 205,220 generates a notification including the counteroffer and option for responding to the counteroffer (e.g. accept, reject, or re counteroffer). For example, the seller interface manipulation engine 205 can generate a notification at block 510 including the counteroffer and an option for responding to the counteroffer. Options for responding to the counteroffer can include an option to re-counteroffer (e.g. present a new counteroffer, including a new counteroffer amount), to accept the pending counteroffer, or to pass on (or reject) the pending counteroffer.

One or both of the response detectors 260, 265 can detect input corresponding to a response. The respective receiver can determine whether the response was an acceptance at block 515. For example, the seller response detector 260 can determine whether the input received corresponded to an acceptance, a rejection, or another counteroffer. In some embodiments, if no input corresponding to a response is detected by one of the response detectors 260, 265 within a pre-set time limit, the respective receiver will determine that a “pass” or “rejection” has occurred. In some embodiments, the buyer 105 and/or seller 115 may select an option corresponding to a request to end the negotiation (or transaction). An individual may review the request to end the negotiation and may input data to an interface corresponding to a selection to end the negotiation. The negotiation management system 150 having received data corresponding to a selection to end the negotiation can end the negotiation. The negotiation management system 150 can generate a notification to the buyer 105 and/or seller 115 indicating the negotiation has been terminated. The negotiation management system 150 can access an order records data store and update an order record associated with the negotiation to indicate the negotiation (or transaction) associated it with the order record has been terminated.

In some embodiments, to limit the length of a negotiation, only a pre-set number of counteroffers may be transmitted to a buyer 105 and/or seller 115. The respective response detector 260,265 can determine at block 515 whether an acceptance was received. If no acceptance was received, but an Nth counteroffer was received at block 520, then the receiver can communicate to the price negotiation engine 235 that an Nth counteroffer was received. The price negotiation engine 235 can determine the Nth value of the pending counteroffer. In some embodiments, one or both of the seller response detector 260 and the buyer response detector 265 can include a counter that can determine the Nth value of the counteroffer.

At block 525, the price negotiation engine 235 compares the Nth value to a pre-set value and determines if N is equal to the pre-set value. The pre-set value can be selected by the negotiation management system as a default value or it can be selected by the buyer 105 and/or seller 115 involved in the current negotiation at the outset of the negotiation. If at block 525 the price negotiation engine 235 determines that N is not equal to the pre-set value, then the process returns to block 510. At block 510, the price negotiation engine 235 communicates with the respective buyer/seller interface manipulation engine which generates a notification including the Nth counteroffer and options for responding, including accept, reject, or re-counteroffer.

If at block 525 the price negotiation engine 235 determines that N is equal to the pre-set value, then the price negotiation engine 235 can communicate to the respective buyer/seller interface manipulation engine 220/205 that N is equal to the pre-set value. The respective interface manipulation engine can generate a notification at block 530 that includes the counteroffer and a limited selection of options to respond to the counteroffer, including an option to accept or reject the Nth counteroffer. By limiting the options for responding to the Nth counteroffer where N is a pre-set value, the negotiation process is thereby limited in duration.

If at block 535 the respective receiver determines that no acceptance was received (e.g. the receiver determines a rejection was received or a pre-set amount of time passed without detecting a response) then at block 540 the process ends the negotiation.

If at block 535 the respective receiver determines that an acceptance of the pending Nth counteroffer was received then the process moves to block 545. If at block 515 the respective receiver determines that an acceptance of the pending counteroffer was received, then the process also moves to block 545. At block 545 the price negotiation engine 235 determines whether the total amount due is less than or equal to a reserve amount. An exemplary process for determining the reserve amount is described in more detail with respect to FIG. 3.

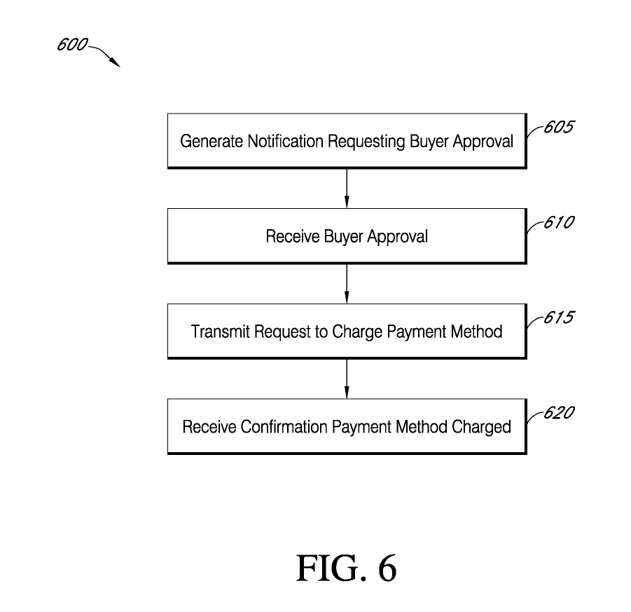

If at block 545 the price negotiation engine 235 determines that the total amount due is less than the reserve amount then the price negotiation engine 235 can transmit a settlement request to a credit card processor 160 to settle the authorization in the reserve amount at block 555. In some embodiments, the price negotiation engine 235 can transmit a settlement request to the credit card processor 160 in an amount different than the reserve amount. For example, the price negotiation engine 235 can transmit a settlement request in an amount equal to the shipping amount. The amount due after the reserve amount has been settled is the balance due amount. The process for collecting the balance due amount is completed at block 560. An exemplary process for collecting the balance due amount is described with reference to FIG. 6 below.

If at block 545 the price negotiation engine 235 determines that the total amount due is less than or equal to the reserve amount then at block 550 the price negotiation engine 235 can transmit a settlement request to the credit card processor 160 in an amount equal to the total amount due.

FIG. 6 illustrates a flowchart of an embodiment of a process 600 for processing a balance due amount associated with the purchase of an item where the total amount due is greater than the reserve amount. When the total amount due is greater than the reserve amount the price negotiation engine 235 can transmit a settlement request to a credit card processor 160 to settle the authorized reserve amount. The credit card processor 160 can communicate a confirmation to the price negotiation engine 235 confirming the reserve amount has been settled. The difference between the total amount due and the now-settled reserve amount is defined as the balance due amount. At block 605 the buyer interface manipulation engine 220 generates a notification that the buyer 105 may access from the buyer device 110. The notification can identify the total amount due, the reserve amount that has been settled and/or the balance due amount. The notification can also include a payment method (e.g. a default payment method or the payment method used for the authorization of the reserve amount) and payment method information. The notification can include a request to indicate approval to charge the buyer's payment method in the balance due amount.

In some embodiments, when the total amount due exceeds the reserve amount, the price negotiation engine 235 may refrain from transmitting request to settle the authorization amount and the buyer interface manipulation engine 220 may instead generate and transmit a notification that identifies the total amount due and request the buyer 105 indicate approval to charge the buyer's payment method in the total amount due. In some embodiments, the notification may be viewed by the buyer logging into the buyer's account.

The buyer response detector 265 detects input corresponding to the buyer's approval to charge the payment method in the balance due amount charge at block 610. In some embodiments, the input corresponding the buyer's approval can be input corresponding to the buyer's selection of a GUI to indicate approval to charge the payment method in the balance due amount. In some embodiments, the input corresponding to the buyer's approval can be an email, SMS message, MMS message, voice message, or other suitable communication indicating approval to charge the buyer's payment method. In some embodiments, the price negotiation engine 235 may have previously received from buyer 105 approval to charge a payment method in any future balance due amount (e.g. at the time the first offer was made or at the time the buyer 105 created an account).

The buyer response detector 265 communicates to the price negotiation engine 235 that input corresponding to the buyer's approval of the balance due amount charge has been detected. At block 615 the price negotiation engine 235 transmits a request to a credit card processor 160 to charge the payment method in the balance due amount (e.g. an authorization and a settlement in the balance due amount). The request can include the balance due amount, the payment method information (e.g. billing address, credit card number, expiration date, etc.), and/or buyer's account information (e.g. buyer's name).

The price negotiation engine can receive a communication from the credit card processor 160 confirming that the payment method was charged (e.g. authorized and/or settled) in the balance due amount at block 620. The price negotiation engine 235 can communicate to the inventory engine 210 that the total amount due has been charged. The inventory engine 210 can update the item record that corresponds to the item that was purchased to reflect that the item has been purchased and paid in full (e.g. purchase complete). Once the item record indicated that the item's purchase has been complete, the inventory engine 210 can cease or inhibit returning the item record in response to a query by a buyer. In some embodiments, the price negotiation engine 235 can communicate to the seller interface manipulation engine 205 that the item has been paid for in full and the seller interface manipulation engine 205 can generate and transmit a notification to the seller 115 confirming the item has been paid for in full. In some embodiments, the notification can include a request to select input corresponding to a confirmation that the item has been shipped by the seller 115.

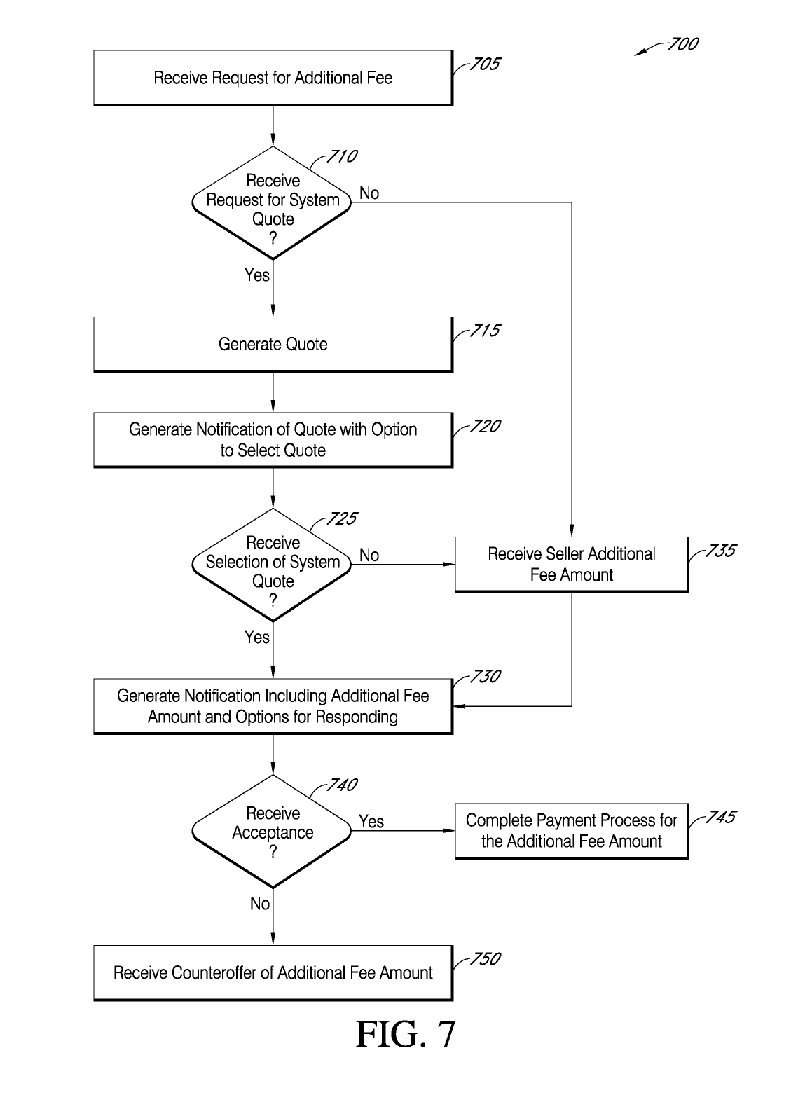

An exemplary embodiment of a process for negotiating and processing an additional fee is depicted in the flowchart of FIG. 7. The process depicted in FIG. 7 can occur, in some embodiments, after an acceptance of a pending offer for purchase of an item has been detected. In some embodiments, the process can occur substantially concurrently with a negotiation to purchase an item. At block 705 the seller response detector 260 detects input corresponding to a request for an additional fee. In some embodiments, the buyer response detector 265 or seller interface manipulation engine 205, or buyer interface manipulation engine 220 can detect input corresponding to the selection of an option to request an additional fee. The additional fee can include, for example but not limited to, a shipping fee and/or an insurance fee. The input can be entered by a seller 115 or can correspond to a selection of an option (e.g. selecting an option to request an additional fee in the amount of $100.00 or an option to request an additional fee in the amount of the quote provided by the system, as described further below). For example, the input can correspond to the selection of an option to submit of a counteroffer that includes an additional fee request or the input can correspond to the selection of an option to accept a pending offer that includes an additional fee request. The input corresponding to the additional fee request can also include input corresponding to a request for the system to provide a quote for the additional fee. In some embodiments, the input corresponding to the additional fee request can include one or more options related to the additional fee (e.g. various levels of shipping service or insurance) from which the buyer 105 may select. The input corresponding to the additional fee request can include an additional fee amount and/or identify type of additional fee that has been requested (e.g. shipping or insurance fee).

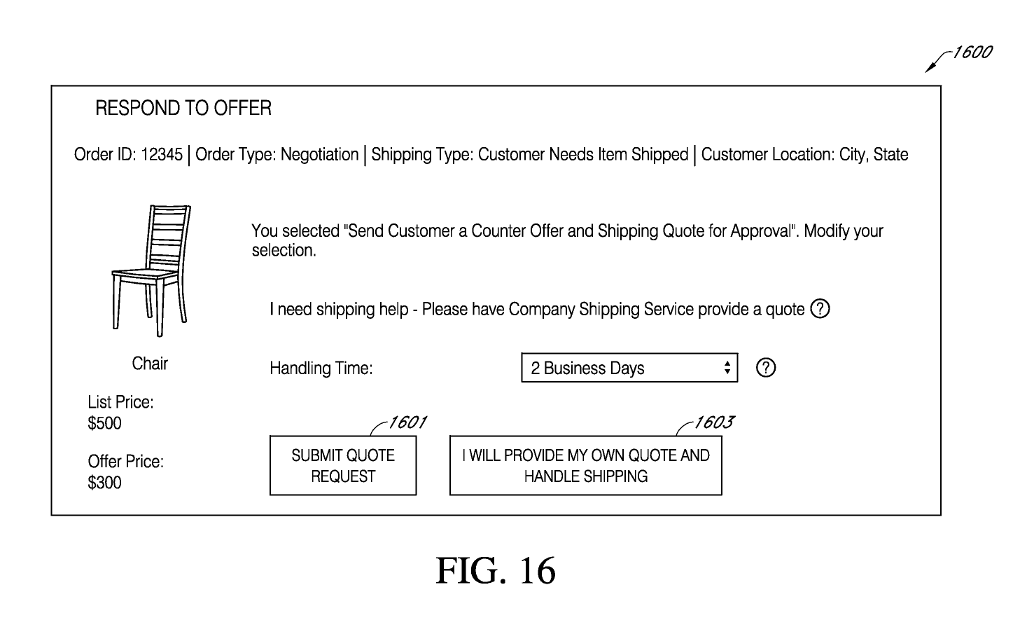

At block 710 the seller response detector 260 determines whether the input corresponds to a request for a system quote to be provided (e.g. the input can correspond to a user selecting the GUI 1601 depicted in FIG. 16). If at block 710 the seller response detector 260 determines that the input corresponds to a request for a system quote for the additional fee, then the seller response detector 260 notifies the price negotiation engine 235 of the receipt of a request for an additional fee quote. In some embodiments, the seller response detector 260 can also notify the price negotiation engine 235 of the type of additional fee.

At block 715 the price negotiation engine 235 can generate a quote for the additional fee. The price negotiation engine 235 can communicate with the account engine 225 and the inventory engine 210 to access information (e.g. seller location, buyer location, item weight, item dimensions) that can be used to generate a quote for the additional fee. For example, the price negotiation engine 235 can generate a quote for shipping the purchased item from the seller 115 to the buyer 105. The price negotiation engine 235 can generate the shipping quote based on the size of the item (as reflected in the item records data store 215) and the buyer and seller's respective locations (as reflected in the buyer account and seller account). In some embodiments, the price negotiation engine 235 can interact with one or more shipping-service servers to request a shipping pricing quote from the shipping-service server. In some embodiments, the price negotiation engine 235 can generate the quote for the additional fee based in whole or in part on data corresponding to prior transactions of the buyer 105 and/or the seller 115. For example, the price negotiation engine 235 can generate a shipping quote based in whole or in part on the seller's previous shipping fees (e.g. seller 115 has previously selected a flat shipping fee of $100). In some embodiments, the price negotiation engine 235 can generate the shipping quote (or other additional fee) based in whole or in part on prior transactions for purchase of similar items. For example, the price negotiation engine 235 can generate the shipping quote or insurance quote for a pair or earrings based on a range of shipping fees or insurance fees in prior transactions for similar items regardless of the buyer 105 and/or the seller 115 in those transactions (e.g. transactions for earrings or transactions for an item with a substantially equal purchase price). In some embodiments, a shipping representative can determine the shipping quote and can input data corresponding to the determined shipping quote.

The price negotiation engine 235 can communicate the additional fee quote to the seller interface manipulation engine 205. In some embodiments, where the request was detected by the buyer response detector 265 or buyer interface manipulation engine 220, the price negotiation engine 235 can notify the buyer interface manipulation engine 220.

At block 720 the seller interface manipulation engine 205 can generate a notification that includes the additional fee quote. The notification can also include an option to provide the system quote to the buyer 105 or to provide a different additional fee amount input by the seller 115.

At block 725 the seller response detector 260 determines if the input corresponding to the option selected by the seller indicates the system quote has been selected (e.g. input identifying that the seller 115 has accepted the system quote to be used as the additional fee). The input corresponding to the option selected by the seller can be a selection made by the seller (e.g. by selecting a radio button or a GUI), an SMS message, an MMS message, or other suitable communication indicating the system quote has been selected.

The seller response detector 260 can transmit the additional fee of the system quote to the price negotiation engine 235. The price negotiation engine 235 can notify the buyer interface manipulation engine 220 of the receipt of the additional fee request, the selected system quote amount, and/or the type of additional fee.

If at block 710 the seller response detector 260 determines that the input did not include a request for a system quote (e.g. the response detector 260 detects input corresponding to the seller's selection to provide their own additional fee quote) for the additional fee then the process proceeds to block 735. Also, if at block 725 the seller response detector 260 detects input corresponding a seller's selection to provide their own additional fee quote instead of using the system quote (e.g. the system quote was not selected) then the process continues to block 735. In some embodiments, the seller response detector 260 may determine that the input corresponds to a selection to provide a quote other than the system quote (e.g., a quote input directly by the seller or a quote uploaded or transmitted from a third party).

At block 735 the seller response detector 260 detects input corresponding to the additional fee (e.g. an additional fee amount) provided by the seller 115. The additional fee can be input corresponding to an amount input by the seller 115 via the seller interface manipulation engine 205 or an option selected by the seller 115 in response to a notification.

The seller response detector 260 can transmit the additional fee detected at block 735 to the price negotiation engine 235. The price negotiation engine 235 can notify the buyer interface manipulation engine 220 of the receipt of the additional fee request, the amount of the request, and/or the type of additional fee.

At block 730 the buyer interface manipulation engine 220 can generate a notification that includes the additional fee request, the additional fee amount, and/or the type of additional fee. The additional fee amount can be the system quote of the additional fee amount (the selection received at block 725) or it can be the additional fee amount input by the seller 115 (received at block 735). The notification can also include an option to respond to additional fee request (e.g. an option to accept, reject, or counteroffer the additional fee).

At block 740 the buyer response detector 265 detects input corresponding to the buyer response to the notification and determines if the input corresponds to an acceptance of the additional fee. The input can correspond to the buyer's selection of an option to respond to the notification by selecting a radio button, an SMS message, an MMS message, or other suitable communication.

If at block 740 the buyer response detector 265 determines that the input corresponds to an acceptance of the additional fee amount included in the notification than the process proceeds to block 745. At block 745 the price negotiation engine completes the payment process for the additional fee amount. The price negotiation engine 235 can retrieve payment method information associated with the buyer's account from the account engine 225. The price negotiation engine 235 can process the payment method associated with the buyer's account as described herein.

If at block 740 the buyer response detector 265 determines that the input does not correspond to the acceptance of the additional fee included in the notification, then the process proceeds to block 750. At block 750 the buyer response detector 265 detects input corresponding to an additional fee counteroffer, including for example an additional fee counteroffer. An iterative counteroffer process can continue, for example, as described with respect to FIG. 5. The process described above with respect to FIG. 7 can apply to various additional fees associated with a purchase, for example, but not limited to, insurance fees and installation fees.

The techniques disclosed herein can facilitate the negotiation of an item's purchase by receiving payment method information from a buyer 105 at the time the buyer 105 provides a first offer for purchase of an item and authorizing the payment method in a reserve amount. By authorizing the payment method in a reserve amount prior to generating and transmitting a notification identifying the first offer to a seller 115, the seller 115 can be confident that payment would be made if the seller 115 chose to accept the first offer. Similarly, if the seller 115 counteroffers the first offer, the seller 115 can remain confident that if during the negotiation a pending offer was accepted a balance due amount could be collected by the system, in some embodiments, without further input required from the buyer 105. A seller's confidence in the ability to collect payment can encourage a seller to engage in a negotiation for purchase.

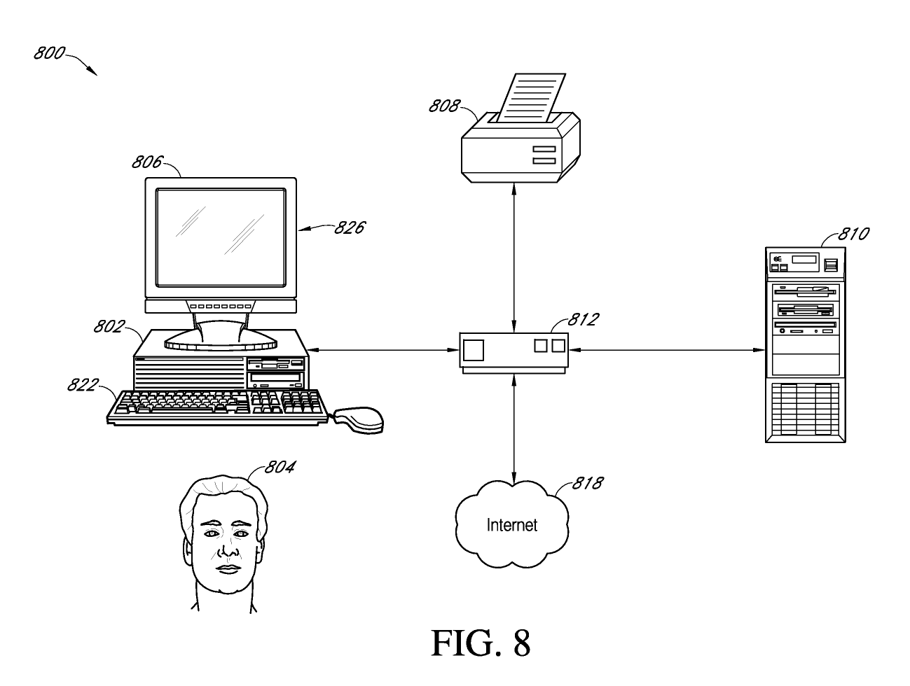

Referring next to FIG. 8, an exemplary environment with which embodiments can be implemented is shown with a computer system 800 that can be used by a designer 804 to design, for example, electronic designs. The computer system 800 can include a computer 802, keyboard 822, a network router 812, a printer 808, and a monitor 806. The monitor 806, computer 802 and keyboard 822 are part of a computer system 826, which can be a laptop computer, desktop computer, handheld computer, mainframe computer, mobile device, etc. Monitor 806 can be a CRT, flat screen, etc. In some embodiments the computer system 800 can be a mobile device.

A designer 804 can input commands into the computer 802 using various input devices, such as a mouse, keyboard 822, track ball, touch screen, etc. If the computer system 800 comprises a mainframe, a designer 804 can access computer 802 using, for example, a terminal or terminal interface. Additionally, computer system 826 can be connected to a printer 808 and a server 810 using a network router 812, which can connect to the Internet 818 or a WAN.

Server 810 can, for example, be used to store additional software programs and data. In one embodiment, software implementing the systems and methods described herein can be stored on a storage medium in server 810. Thus, the software can be run from the storage medium in server 810. In another embodiment, software implementing the systems and methods described herein can be stored on a storage medium in computer 802. Thus, the software can be run from the storage medium in computer system 826. Therefore, in this embodiment, the software can be used whether or not computer 802 is connected to network router 812. Printer 808 can be connected directly to computer 802, in which case, computer system 826 can print whether or not it is connected to network router 812.

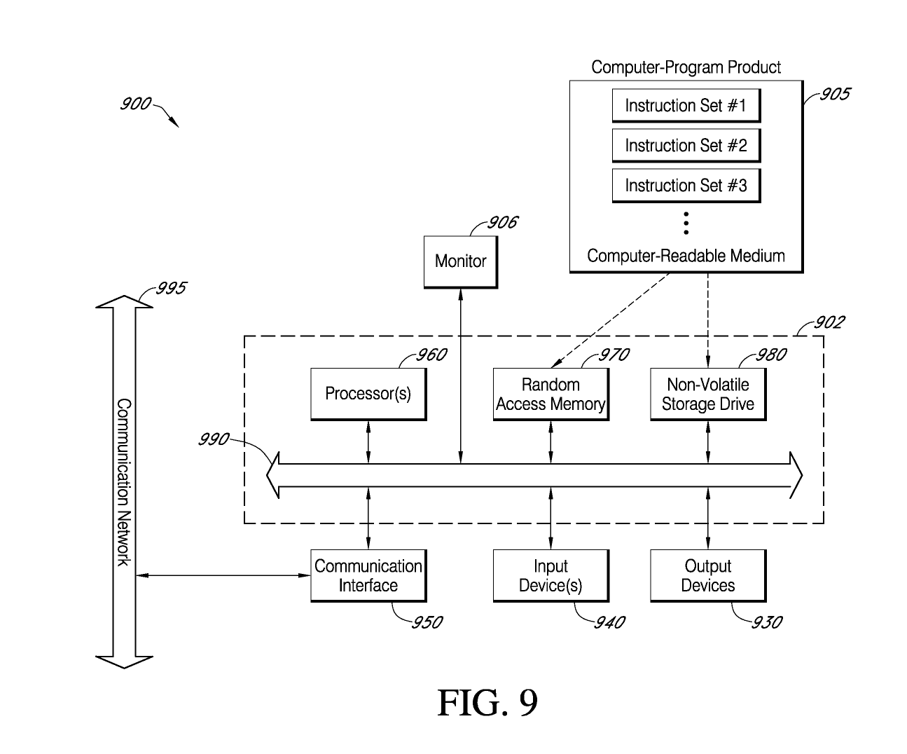

With reference to FIG. 9, an embodiment of a special-purpose computer system 900 is shown. In some embodiments, the special-purpose computer system 900 is present within a mobile device. A negotiation management system 150 and/or any components of that system are examples of a special-purpose computer system 900. Thus, for example, one or more special-purpose computer systems 900 can be used to provide the function of the negotiation management system 150. The above methods can be implemented by computer-program products that direct a computer system to perform the actions of the above-described methods and components. Each such computer-program product can comprise sets of instructions (codes) embodied on a computer-readable medium that directs the processor of a computer system to perform corresponding actions. The instructions can be configured to run in sequential order, or in parallel (such as under different processing threads), or in a combination thereof. After loading the computer-program products on a general purpose computer system 826, it is transformed into the special-purpose computer system 900.

Special-purpose computer system 900 comprises a computer 902, a monitor 906 coupled to computer 902, one or more additional user output devices 930 (optional) coupled to computer 902, one or more user input devices 940 (e.g., keyboard, mouse, track ball, touch screen) coupled to computer 902, an optional communications interface 950 coupled to computer 902, a computer-program product 905 stored in a tangible computer-readable memory in computer 902. Computer-program product 905 directs system 900 to perform the above-described methods. Computer 902 can include one or more processors 960 that communicate with a number of peripheral devices via a bus subsystem 990. These peripheral devices can include user output device(s) 930, user input device(s) 940, communications interface 950, and a storage subsystem, such as random access memory (RAM) 970 and non-volatile storage drive 980 (e.g., disk drive, optical drive, solid state drive), which are forms of tangible computer-readable memory.

Computer-program product 905 can be stored in non-volatile storage drive 980 or another computer-readable medium accessible to computer 902 and loaded into memory 970. Each processor 960 can comprise a microprocessor, such as a microprocessor from Intel® or Advanced Micro Devices, Inc®, or the like. To support computer-program product 905, the computer 902 runs an operating system that handles the communications of product 905 with the above-noted components, as well as the communications between the above-noted components in support of the computer-program product 905. Exemplary operating systems include Windows® or the like from Microsoft Corporation, Solaris® from Sun Microsystems, LINUX, UNIX, and the like.

User input devices 940 include all possible types of devices and mechanisms to input information to computer system 902. These can include a keyboard, a keypad, a mouse, a scanner, a digital drawing pad, a touch screen incorporated into the display, audio input devices such as voice recognition systems, microphones, and other types of input devices. In various embodiments, user input devices 940 are typically embodied as a computer mouse, a trackball, a track pad, a joystick, wireless remote, a drawing tablet, a voice command system. User input devices 940 typically allow a user to select objects, icons, text and the like that appear on the monitor 906 via a command such as a click of a button or the like. User output devices 930 include all possible types of devices and mechanisms to output information from computer 902. These can include a display (e.g., monitor 906), printers, non-visual displays such as audio output devices, etc.

Communications interface 950 provides an interface to other communication networks and devices and can serve as an interface to receive data from and transmit data to other systems, WANs and/or the Internet 818. Embodiments of communications interface 950 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 950 can be coupled to a communication network 995, to a FireWire® bus, or the like. In some embodiments, communications interface 950 can be physically integrated on the motherboard of computer 902, and/or can be a software program, or the like.

RAM 970 and non-volatile storage drive 980 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 970 and non-volatile storage drive 980 can be configured to store the basic programming and data constructs that provide the functionality of various embodiments of the present invention, as described above.

Software instruction sets that provide the functionality of the present invention can be stored in RAM 970 and non-volatile storage drive 980. These instruction sets or code can be executed by processor(s) 960. RAM 970 and non-volatile storage drive 980 can also provide a repository to store data and data structures used in accordance with the present invention. RAM 970 and non-volatile storage drive 980 can include a number of memories including a main random access memory (RAM) to store of instructions and data during program execution and a read-only memory (ROM) in which fixed instructions are stored. RAM 970 and non-volatile storage drive 980 can include a file storage subsystem providing persistent (non-volatile) storage of program and/or data files. RAM 970 and non-volatile storage drive 980 can also include removable storage systems, such as removable flash memory.

Bus subsystem 990 provides a mechanism to allow the various components and subsystems of computer 902 communicate with each other as intended. Although bus subsystem 990 is shown schematically as a single bus, alternative embodiments of the bus subsystem can utilize multiple busses or communication paths within computer 902.

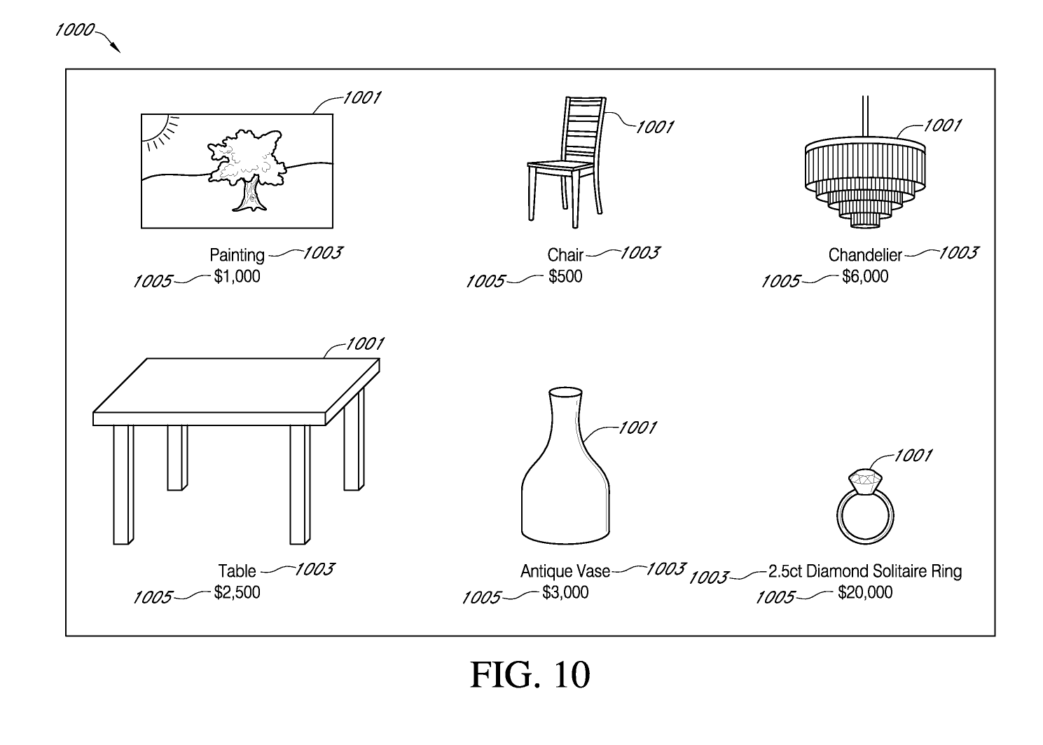

FIG. 10 depicts an exemplary screen shot of an interface (e.g., a webpage) presenting multiple item identifications presented to the buyer 105 by the buyer interface manipulation engine 220. As shown in FIG. 10, the interface 1000 can include, for each of a set of items, an image of the item 1001, a name of the item 1003, and an asking price of the item 1005.

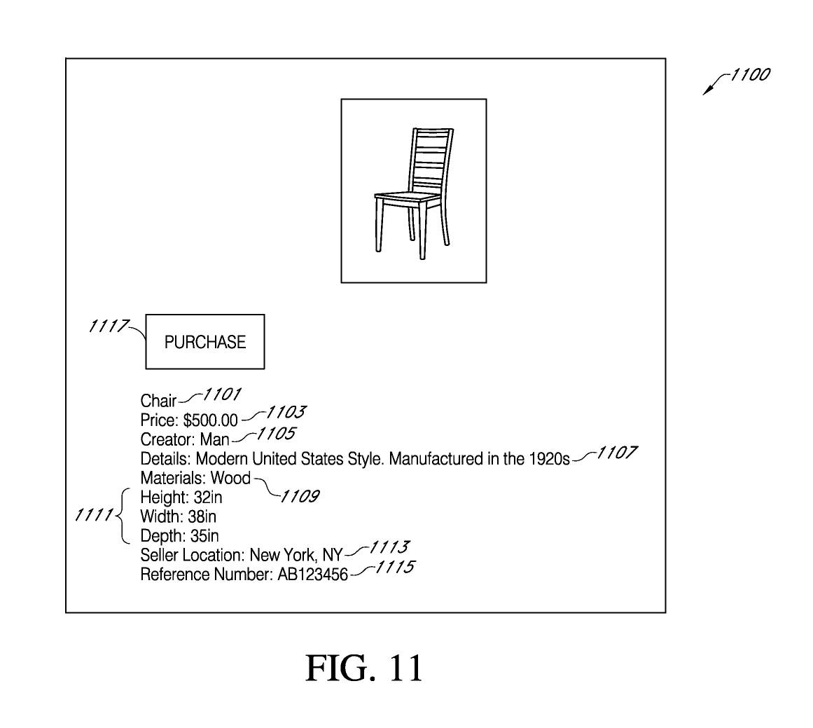

FIG. 11 depicts an exemplary screen shot of an interface presenting a detailed item offering presented to the buyer 105 by the buyer interface manipulation engine 220 in response to the detection of input corresponding to the selection of a particular item identification. As shown in FIG. 11, the detailed item offering 1100 can include, for example, the item name 1101, asking price 1103, creator 1105, additional details 1107, material of manufacture 1109, dimensions 1111, seller location 1113 (in this example the seller's location indicates the item's location), and a reference number 1115 corresponding to the item record stored in the item records data store 215. The interface can also include a GUI “purchase” button 1117 which when selected can provide input corresponding to a request to purchase the item. In some embodiments, the interface can include a GUI button that when selected can provide input corresponding to a request to contact the seller 115 or request to make a first offer for purchase of the item.

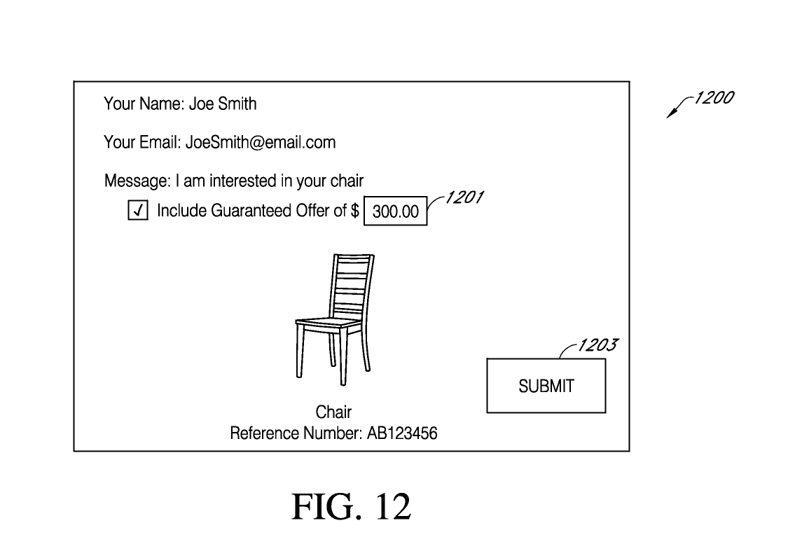

FIG. 12 depicts an exemplary screen shot of an interface 1200 presented by the buyer interface manipulation engine 220 in response to detecting input corresponding to a request to make a first offer for purchase of an item. The interface 1200 can detect a first offer amount input in the data field 1201 and the submission of the first offer by the selection of GUI 1203.

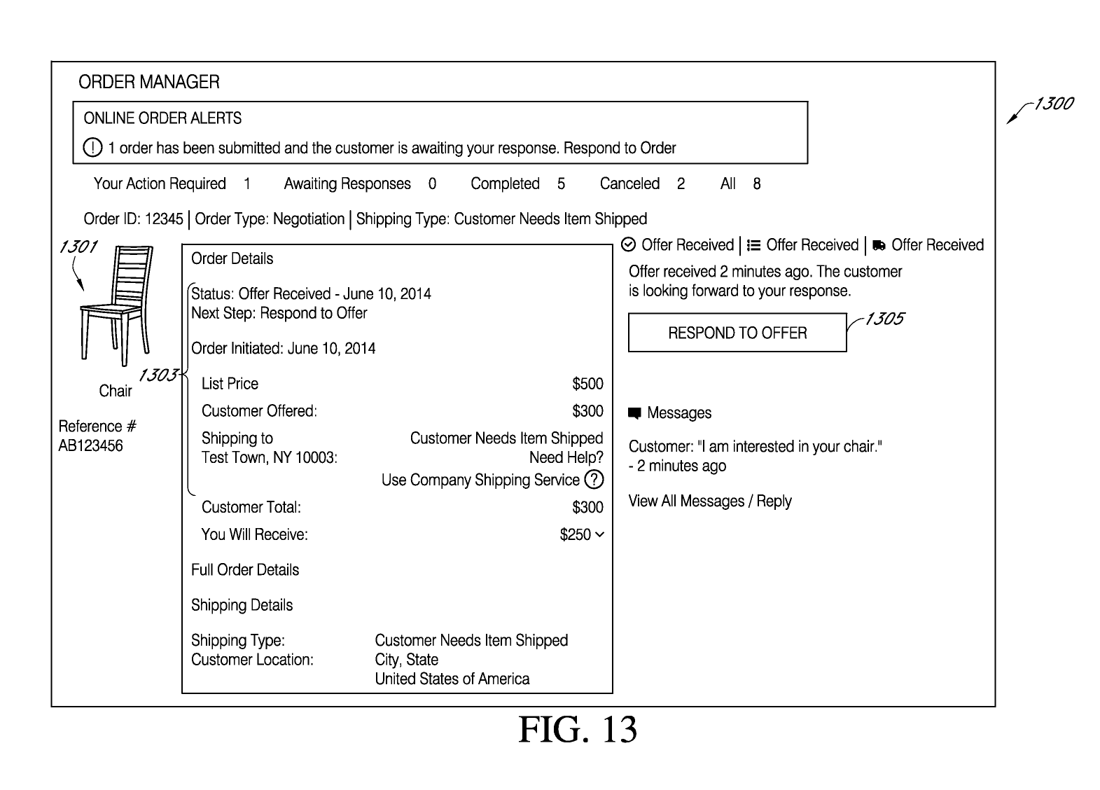

FIG. 13 depicts an exemplary screen shot of a notification generated by the seller interface manipulation engine 205 identifying a first offer. The notification 1300 can include an item identifier 1301, a summary of the pending offer 1303, and an option to respond to the first offer 1305. If the seller interface manipulation engine 205 detects input corresponding to a selection to respond to the first offer, the seller interface manipulation engine 205 can present an interface including various options for responding.

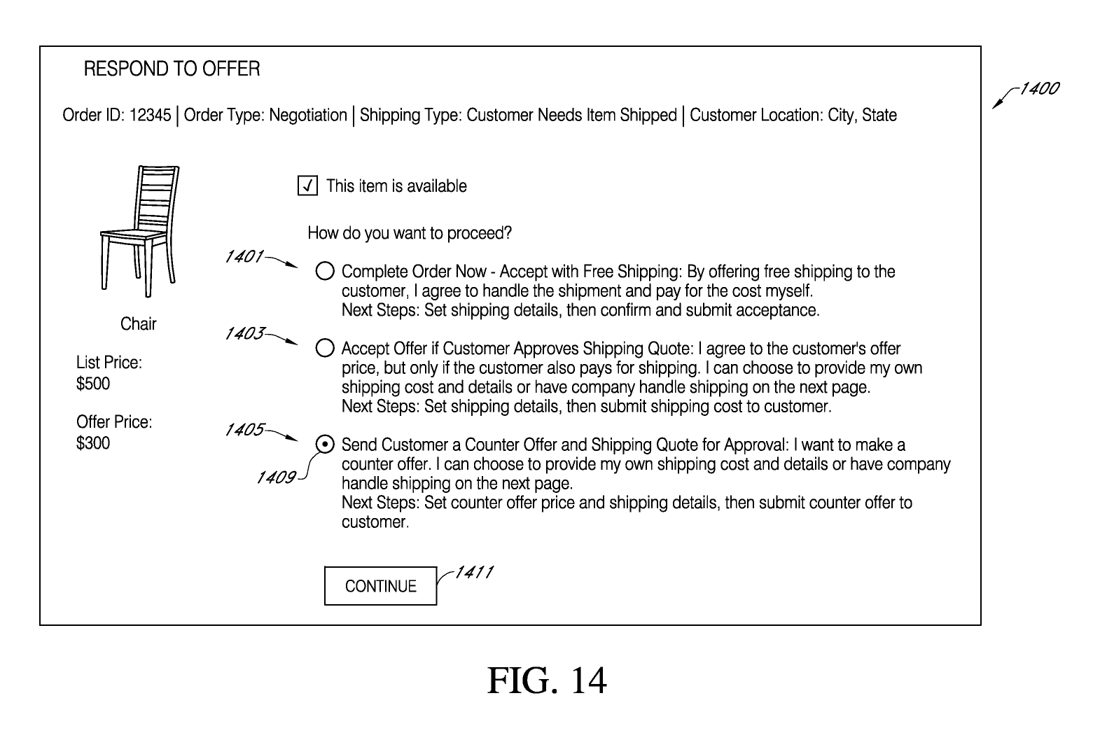

FIG. 14 depicts an exemplary screen capture of an interface 1400 generated by the seller interface manipulation engine 205 for receiving input corresponding to a response to a first offer. The options presented to the seller 115 in the example of FIG. 14 include an option to accept the first offer and provide shipping free of cost to the buyer 1401, an option to accept the first offer and provide the buyer with a shipping fee for approval 1403, and an option to a counteroffer and request a shipping fee for approval 1405. In the exemplary screen shot of FIG. 14, the option to send the buyer a counteroffer and a shipping fee 1405 has been selected as indicated by the selected radio button 1409. The selected response option can be submitted by selecting the GUI 1411.

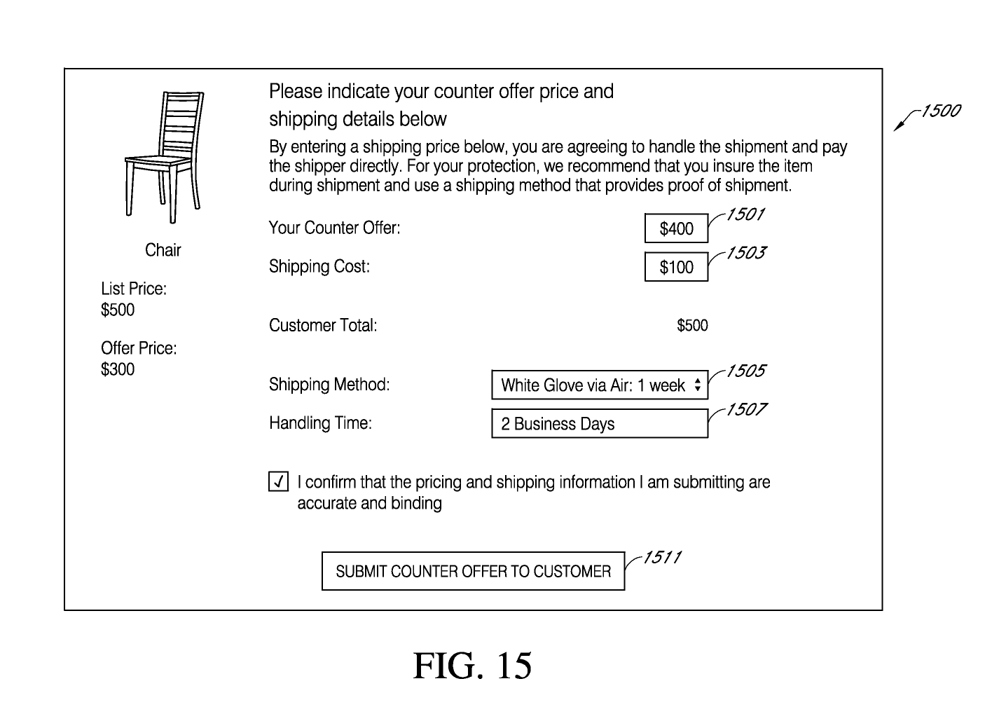

FIG. 15 depicts and exemplary screen shot of an interface 1500 presented by the seller interface manipulation engine 205 in response to having detected input corresponding to the selection to counteroffer and request a shipping fee. The interface 1500 includes data fields corresponding to a counteroffer amount 1501, a shipping fee 1503, a drop-down menu of options for selecting the shipping method 1505, and an estimated handling time 1507, as well as a GUI button 1511 to submit the information to the seller interface manipulation engine 205.

FIG. 16 depicts an exemplary screen shot of an interface 1600 that may be presented by the seller interface manipulation engine 205 that prompts the seller 115 to request a shipping quote from the system or provide their own shipping quote. The exemplary screen shot includes an option to request a quote from the system by selecting GUI 1601 and an option to provide a shipping quote by selecting GUI 1603. In some embodiments, the seller 115 can select the handling time for shipment, for example by selecting a time period from a drop down menu. The seller interface manipulation engine 205 can detect input corresponding to the seller's selection.

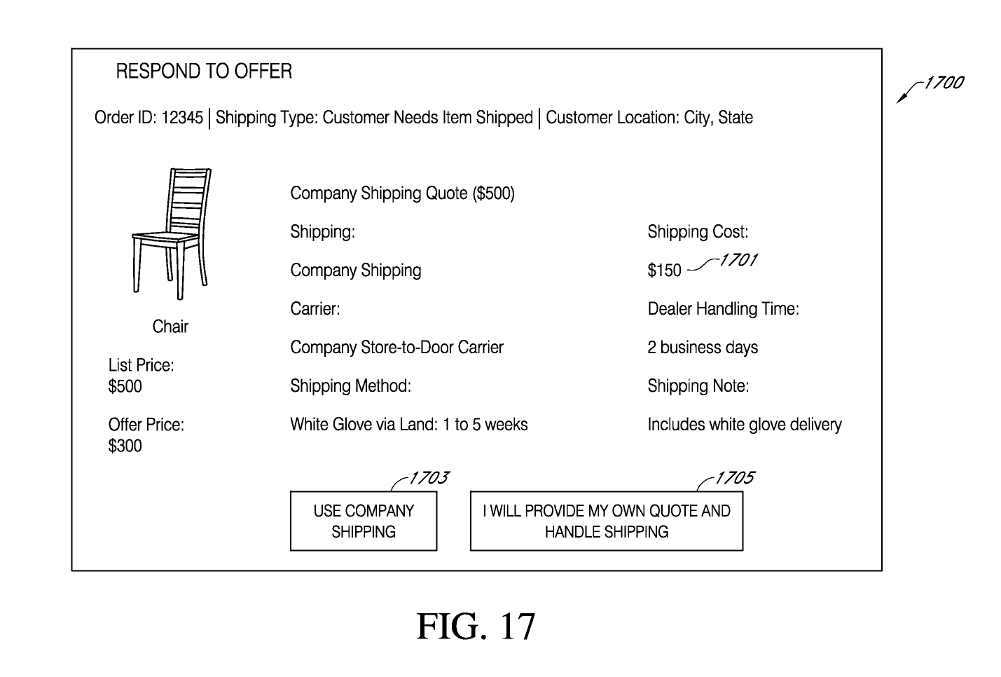

FIG. 17 depicts an exemplary screen shot of an interface 1700 that includes the shipping quote 1701 provided by the system, a GUI 1703 corresponding to a selection to use the system (or company) shipping quote, and a GUI 1705 corresponding to a selection to provide a shipping quote. In some embodiments, the seller 115 can select from various levels of shipping service, for example by selecting a level of service from a drop down menu. For example, the seller 115 can select from options that can include, but are not limited to, (a) white glove service that entails having the item packaged and shipped by a third party, (b) the seller 115 packages the item themselves and a third party picks up the packaged item for shipment, and (c) the seller 115 packages the item themselves and the seller 115 delivers the packaged item to a drop off location for shipment to the buyer 105. The seller interface manipulation engine 205 can detect input corresponding to the seller's selection.

While the principles of the disclosure have been described above in connection with specific apparatuses and methods, it is to be clearly understood that this description is made only by way of example and not as limitation on the scope of the disclosure.

1. A computer-implemented method, comprising:
providing, at a computing device, a presentation offering an item for sale at a sale price;
receiving, at the computing device, an offer for purchase of the item, wherein the offer identifies an offer amount different than the sale price;
receiving, at the computing device, payment method information related to a payment method, wherein the payment method information includes information sufficient to process a purchase of the item for the offer amount different than the sale price according to the payment method;
estimating, at the computing device, a shipping cost based on a location from which the item is to be shipped;
determining, at the computing device, a reserve amount that is greater than or equal to a combination of the offer amount and the estimated shipping cost;
transmitting, from the computing device, a request to authorize the payment method in the reserve amount;
receiving, at the computing device, a confirmation that the payment method is authorized in the reserve amount, wherein the confirmation, when received at the computing device, indicates that the reserve amount is being held until expiration of the offer; and
generating, at the computing device, a notification identifying the item and the offer, the notification including an option to respond to the offer, wherein the option to respond includes an option to accept the offer and an option to provide a counteroffer.

2. The method of claim 1, further comprising:
receiving a response to the offer, wherein the response corresponds to an acceptance of the offer; and
transmitting, from the computing device, a request to settle the authorization of the payment method in an amount less than or equal to the reserve amount.

3. (canceled)

4. The method of claim 1, further comprising:
receiving, at the computing device, a response to the offer, wherein the response corresponds to an acceptance of the offer;
receiving, at the computing device and substantially concurrently with the response, a request for an additional fee of an additional fee amount;
generating, at the computing device, a notification of the acceptance of the offer;
wherein the notification includes an option to respond to the request for the additional fee, the option to respond to the request for the additional fee including an option to accept the additional fee and an option to counteroffer the additional fee;
receiving, at the computing device, a response to the request for an additional fee, wherein the response is an acceptance of the additional fee; and
transmitting, from the computing device, one or more requests to settle the payment method in an amount greater than or equal to a combination of the reserve fee and the additional fee.

5. (canceled)

6. The method of claim 1, further comprising:
receiving, at the computing device, a response to the offer, wherein the response corresponds to a counteroffer including a counteroffer amount;
receiving, at the computing device, an acceptance of the counteroffer;
determining, at the computing device, a balance due amount based on the counteroffer amount and the reserve amount;
transmitting, from the computing device, a request to settle the authorization of the payment method in the reserve amount; and
transmitting, from the computing device, a request to charge the payment method in the balance due amount.

7. The method of claim 1, further comprising:
updating, at the computing device, an item record associated with the item to reflect the payment method has been authorized in the reserve amount.

8. A system, comprising:
one or more data processors; and
a non-transitory computer readable storage medium containing instructions which when executed on the one or more data processors, cause the one or more data processors to perform actions including:
providing, at a computing device, a presentation offering an item for sale;
receiving an offer for purchase of the item, wherein the offer identifies an offer amount different than the sale price;
receiving payment method information related to a payment method, wherein the payment method information includes information sufficient to process a purchase of the item for the offer amount different than the sale price according to the payment method;
estimating a shipping cost based on a location from which the item is to be shipped;
determining a reserve amount that is greater than or equal to a combination of the offer amount and the estimated shipping cost;
transmitting a request to authorize the payment method in the reserve amount;
receiving a confirmation that the payment method is authorized in the reserve amount, wherein the confirmation, when received at the computing device, indicates that the reserve amount is being held until expiration of the offer; and
generating a notification identifying the item and the offer, the notification including an option to respond to the offer, wherein the option to respond includes an option to accept the offer and an option to provide a counteroffer.

9. The system of claim 8, wherein the non-transitory computer readable storage medium further contains instructions which when executed on the one or more data processors, cause the one or more data processors to perform actions including:
receiving a response to the offer, wherein the response corresponds to an acceptance of the offer; and
transmitting a request to settle the authorization of the payment method in an amount less than or equal to the reserve amount.

10. (canceled)

11. The system of claim 8, wherein the non-transitory computer readable storage medium further contains instructions which when executed on the one or more data processors, cause the one or more data processors to perform actions including:
receiving a response to the offer, wherein the response corresponds to an acceptance of the offer;
receiving, substantially concurrently with the response a request for an additional fee of an additional fee amount;
generating a notification of the acceptance of the offer; wherein the notification includes an option to respond to the request for the additional fee, the option to respond to the request for the additional fee including an option to accept the additional fee and an option to counteroffer the additional fee;
receiving a response to the request for an additional fee, wherein the response is an acceptance of the additional fee; and
transmitting one or more requests to settle the payment method in an amount greater than or equal to a combination of the reserve fee and the additional fee.

12. (canceled)

13. The system of claim 8, wherein the non-transitory computer readable storage medium further contains instructions which when executed on the one or more data processors, cause the one or more data processors to perform actions including:
receiving a response to the offer, wherein the response corresponds to a counteroffer including a counteroffer amount;
receiving an acceptance of the counteroffer;
determining a balance due amount based on the counteroffer amount and the reserve amount;
transmitting a request to settle the authorization of the payment method in the reserve amount; and
transmitting a request to charge the payment method in the balance due amount.

14. The system of claim 8, wherein the non-transitory computer readable storage medium further contains instructions which when executed on the one or more data processors, cause the one or more data processors to perform actions including:
updating an item record associated with the item to reflect the payment method has been authorized in the reserve amount.

15. A computer-program product tangibly embodied in a non-transitory machine-readable storage medium, including instructions configured to cause one or more data processors to perform actions including:
providing, at a computing device, a presentation offering an item for sale at a sale price;
receiving, at the computing device, an offer for purchase of the item, wherein the offer identifies an offer amount different than the sale price;
receiving, at the computing device, payment method information related to a payment method, wherein the payment method information includes information sufficient to process a purchase of the item for the offer amount different than the sale price according to the payment method;
estimating, at the computing device, a shipping cost based on a location from which the item is to be shipped;
determining, at the computing device, a reserve amount that is greater than or equal to a combination of the offer amount and the estimated shipping cost;
transmitting, from the computing device, a request to authorize the payment method in the reserve amount;
receiving, at the computing device, a confirmation that the payment method is authorized in the reserve amount, wherein the confirmation, when received at the computing device, indicates that the reserve amount is being held until expiration of the offer; and
generating, at the computing device, a notification identifying the item and the offer, the notification including an option to respond to the offer, wherein the option to respond includes an option to accept the offer and an option to provide a counteroffer.

16. The computer-program product tangibly embodied in a non-transitory machine-readable storage medium of claim 15, further including instructions configured to cause one or more data processors to perform actions including:
receiving, at the computing device, a response to the offer, wherein the response corresponds to an acceptance of the offer; and
transmitting, from the computing device, a request to settle the authorization of the payment method in an amount less than or equal to the reserve amount.

17. (canceled)

18. The computer-program product tangibly embodied in a non-transitory machine-readable storage medium of claim 15, further including instructions configured to cause one or more data processors to perform actions including:
receiving, at the computing device, a response to the offer, wherein the response corresponds to an acceptance of the offer;
receiving, at the computing device and substantially concurrently with the response, a request for an additional fee of an additional fee amount;
generating, at the computing device, a notification of the acceptance of the offer; wherein the notification includes an option to respond to the request for the additional fee, the option to respond to the request for the additional fee including an option to accept the additional fee and an option to counteroffer the additional fee;
receiving, at the computing device, a response to the request for an additional fee, wherein the response is an acceptance of the additional fee; and
transmitting, from the computing device, one or more requests to settle the payment method in an amount greater than or equal to a combination of the reserve fee and the additional fee.

19. (canceled)

20. The computer-program product tangibly embodied in a non-transitory machine-readable storage medium of claim 15, further including instructions configured to cause one or more data processors to perform actions including:
receiving, at the computing device, a response to the offer, wherein the response corresponds to a counteroffer including a counteroffer amount;
receiving, at the computing device, an acceptance of the counteroffer;
determining, at the computing device, a balance due amount based on the counteroffer amount and the reserve amount;
transmitting, from the computing device, a request to settle the authorization of the payment method in the reserve amount; and
transmitting, from the computing device, a request to charge the payment method in the balance due amount.

21. The method of claim 1, wherein the notification includes an indication that the offer is guaranteed by a guaranteeing entity.

22. The method of claim 1, wherein the notification includes an indication that the payment method has been authorized for an amount at least equal to the offer amount.
